(19) United States
(12) Patent Application Publication
(10) Pub. No.: US 2023/0344038 A1
(43) Pub. Date: Oct. 26, 2023

(54) BATTERY SYSTEM WITH COOLER BEAMS

(71) Applicant: SAMSUNG SDI CO., LTD., Yongin-si (KR)

(72) Inventor: Michael ERHART, Seiersberg-Pirka (AT)

(21) Appl. No.: 18/304,851

(22) Filed: Apr. 21, 2023

(30) Foreign Application Priority Data
Apr. 22, 2022 (EP) 22169362.5
Apr. 21, 2023 (KR) 10-2023-0052800

(51) Int. Cl. H01M 10/6568; H01M 50/209; H01M 10/658; H01M 50/293; H01M 10/48; H01M 10/63

(52) U.S. Cl. CPC H01M 10/6568; H01M 50/209; H01M 10/658; H01M 50/293; H01M 10/482; H01M 10/63; H01M 2010/4271

(57) ABSTRACT

A battery system includes a plurality of cell rows, each including a plurality of cells arranged along a first direction; a plurality of cooler beams; and a channel system including a plurality of main channels, each being configured to guide a coolant. Each of the cell rows is sub-divided into a plurality of blocks, and in each block, the front side positively abuts the second side of one cooler beam and/or the rear side positively abuts the first side of another cooler beam. For each of the cooler beams, one of the main channels is integrated therein and is thermally connected thereto.

### CROSS-REFERENCE TO RELATED APPLICATION

This application claims priority to and the benefit of European Patent Application No. 22169362.5, filed in the European Patent Office on Apr. 22, 2022, and Korean Patent Application No. 10-2023-0052800, filed in the Korean Intellectual Property Office on Apr. 21, 2023, the entire content of both of which are incorporated herein by reference.

### BACKGROUND

### 1. Field

Aspects of embodiments of the present disclosure refer to a battery system with cooler beams.

### 2. Description of the Related Art

Recently, vehicles for transportation of goods and peoples have been developed that use electric power as a source for motion. Such an electric vehicle is an automobile that is propelled by an electric motor using energy stored in rechargeable batteries. An electric vehicle may be solely powered by batteries or may be a hybrid vehicle powered by, for example, a gasoline generator or a hydrogen fuel power cell. A hybrid vehicle may include a combination of electric motor and conventional combustion engine. Generally, an electric-vehicle battery (EVB or traction battery) is a battery used to power the propulsion of battery electric vehicles (BEVs). Electric-vehicle batteries differ from starting, lighting, and ignition batteries in that they are designed to provide power for sustained periods of time. A rechargeable (or secondary) battery differs from a primary battery in that it is designed to be repeatedly charged and discharged, while the latter is designed to provide an irreversible conversion of chemical to electrical energy. Low-capacity rechargeable batteries are used as power supplies for small electronic devices, such as cellular phones, notebook computers, and camcorders, while high-capacity rechargeable batteries are used as power supplies for electric and hybrid vehicles and the like.

Generally, rechargeable batteries include an electrode assembly including a positive electrode, a negative electrode, and a separator interposed between the positive and negative electrodes, a case receiving (or accommodating) the electrode assembly, and an electrode terminal electrically connected to the electrode assembly. An electrolyte solution is injected into the case to enable charging and discharging of the battery via an electrochemical reaction of the positive electrode, the negative electrode, and the electrolyte solution. The shape of the case, such as cylindrical or rectangular, may be selected based on the battery's intended purpose. Lithium-ion (and similar lithium polymer) batteries, widely known via their use in laptops and consumer electronics, dominate the most recent electric vehicles in development.

Rechargeable batteries may be used as a battery module formed of a plurality of unit battery cells coupled together in series and/or in parallel to provide a high energy content, such as for motor driving of a hybrid vehicle. The battery module may be formed by interconnecting the electrode terminals of the plurality of unit battery cells in a manner depending on a desired amount of power and to realize a high-power rechargeable battery.

Battery modules can be constructed either in a block design or in a modular design. In the block design, each battery is coupled to a common current collector structure and a common battery management system, and the unit thereof is arranged in a housing. In the modular design, pluralities of battery cells are connected together to form submodules, and several submodules are connected together to form the battery module. In automotive applications, battery systems generally include a plurality of battery modules connected together in series to provide a desired voltage. The battery modules may include submodules with a plurality of stacked battery cells, and each stack includes cells connected in parallel that are, in turn, connected in series (XpYs) or cells connected in series that are, in turn, connected in parallel (XsYp).

A battery pack is a set of any number of (usually identical) battery modules. The battery modules may be configured in series, parallel, or a mixture of both to deliver the desired voltage, capacity, and/or power density. Components of a battery pack include the individual battery modules and the interconnects, which provide electrical conductivity between the battery modules.

A battery system may also include a battery management system (BMS), which is any suitable electronic system that is configured to manage the rechargeable battery, battery module, and battery pack, such as by protecting the batteries from operating outside their safe operating area, monitoring their states, calculating secondary data, reporting that data, controlling its environment, authenticating it, and/or balancing it. For example, the BMS may monitor the state of the battery as represented by voltage (e.g., a total voltage of the battery pack or battery modules and/or voltages of individual cells), temperature (e.g., an average temperature of the battery pack or battery modules, coolant intake temperature, coolant output temperature, and/or temperatures of individual cells), coolant flow (e.g., flow rate and/or cooling liquid pressure), and current. Additionally, the BMS may calculate values based on the above parameters, such as minimum and maximum cell voltage, state of charge (SOC) or depth of discharge (DOD) to indicate the charge level of the battery, state of health (SOH; a variously-defined measurement of the remaining capacity of the battery as % of the original capacity), state of power (SOP; the amount of power available for a defined time interval given the current power usage, temperature and other conditions), state of safety (SOS), maximum charge current as a charge current limit (CCL), maximum discharge current as a discharge current limit (DCL), and internal impedance of a cell (to determine open circuit voltage).

The BMS may be centralized such that a single controller is connected to the battery cells through a multitude of wires. In other examples, the BMS may be distributed, with a BMS board installed at each cell, with just a single communication cable between the battery and a controller. In yet other examples, the BMS may have a modular construction including a few controllers, each handling a certain number of cells while communicating between the controllers. Centralized BMSs are most economical but are least expandable and are plagued by a multitude of wires. Distributed BMSs are the most expensive but are simplest to install and offer the cleanest assembly. Modular BMSs provide a compromise of the features and problems of the other two topologies.

A BMS may protect the battery pack from operating outside its safe operating area. Operation outside the safe operating area may be indicated by over-current, over-voltage (during charging), over-temperature, under-temperature, over-pressure, and ground fault or leakage current detection. The BMS may prevent the battery from operating outside its safe operating parameters by including an internal switch (e.g., a relay or solid-state device) that opens if the battery is operated outside its safe operating parameters, requesting the devices to which the battery is connected to reduce or even terminate using the battery, and actively controlling the environment, such as through heaters, fans, air conditioning or liquid cooling.

The mechanical integration of such a battery pack requires appropriate mechanical connections between the individual components (e. g., within battery modules and between them and a supporting structure of the vehicle). These connections must remain functional and safe during the average service life of the battery system. Further, installation space and interchangeability requirements must be met, especially in mobile applications.

Mechanical integration of battery modules may be achieved by providing a carrier framework and by positioning the battery modules thereon. Fixing the battery cells or battery modules may be achieved by fitted depressions in the framework or by mechanical interconnectors, such as bolts or screws. In some cases, the battery modules are confined by fastening side plates to lateral sides of the carrier framework. Further, cover plates may be fixed atop and below the battery modules.

The carrier framework of the battery pack is mounted to a carrying structure of the vehicle. When the battery pack is to be fixed at the bottom of the vehicle, the mechanical connection may be established from the bottom side by, for example, bolts passing through the carrier framework of the battery pack. The framework is usually made of aluminum or an aluminum alloy to lower the total weight.

Static control of battery power output and charging may not be sufficient to meet the dynamic power demands of various electrical consumers connected to the battery system. Thus, steady exchange of information between the battery system and the controllers of the electrical consumers may be employed. This information may include the battery system's actual state of charge (SoC), potential electrical performance, charging ability, and internal resistance as well as actual or predicted power demands or surpluses of the consumers. Therefore, battery systems usually include a battery management system (BMS) for obtaining and processing such information on a system level and may also include a plurality of battery module units (BMUs), which are part of the system's battery modules and obtain and process relevant information on a module level. The BMS usually measures the system voltage, the system current, the local temperature at different places inside the system housing, and the insulation resistance between live components and the system housing while the BMMs usually measure the individual cell voltages and temperatures of the battery cells in a battery module.

The BMS/BMU is provided to manage the battery pack, such as by protecting the battery from operating outside its safe operating area (or safe operating parameters), monitoring its state, calculating secondary data, reporting that data, controlling its environment, authenticating it, and/or balancing it.

In case of an abnormal operation state (or in the event of an abnormal condition), a battery pack should be disconnected from a load connected to a terminal of the battery pack. Therefore, battery systems may include a battery disconnect unit (BDU) that is electrically connected between the battery module and battery system terminals. The BDU is the primary interface between the battery pack and the electrical system of the vehicle. The BDU includes electromechanical switches that open or close high current paths between the battery pack and the electrical system. The BDU provides feedback to the battery control unit (BCU) accompanied to the battery modules such as voltage and current measurements. The BCU controls the switches in the BDU by using low current paths based on the feedback received from the BDU. The primary functions of the BDU may include controlling current flow between the battery pack and the electrical system and current sensing. The BDU may further manage additional functions, such as external charging and pre-charging.

An active or passive thermal management system may be included to provide thermal control of the battery pack to safely use the at least one battery module by efficiently emitting, discharging, and/or dissipating heat generated from its rechargeable batteries. If the heat emission, discharge, and/or dissipation is not sufficiently performed, temperature deviations may occur between respective battery cells, such that the at least one battery module may no longer generate a desired (or designed) amount of power. In addition, an increase of the internal temperature can lead to abnormal reactions occurring therein, and thus, charging and discharging performance of the rechargeable battery deteriorates and the lifespan of the rechargeable battery is shortened.

Exothermic decomposition of cell components may lead to a so-called thermal runaway. Generally, thermal runaway describes (or refers to) a process that is accelerated by increased temperature, in turn releasing energy that further increases temperature. Thermal runaway occurs in situations where an increase in temperature changes the conditions in a rechargeable battery a way that causes a further increase in temperature, often leading to a destructive result. In rechargeable battery systems, thermal runaway is associated with strong exothermic reactions that are accelerated by temperature rise. These exothermic reactions include combustion of flammable gas compositions within the battery pack housing. For example, when a cell is heated above a critical temperature (typically above about 150° C.), it can transit into (or transition into) a thermal runaway. The initial heating may be caused by a local failure, such as a cell internal short circuit, heating from a defective electrical contact, short circuit to a neighboring cell, etc. During the thermal runaway, a failed battery cell (e.g., a battery cell which has a local failure) may reach a temperature exceeding about 700° C. Further, large quantities of hot gas are ejected from inside the failed battery cell through a venting opening in the cell housing into the battery pack. The main components of the vented gas are H₂, CO₂, CO, electrolyte vapor, and other hydrocarbons. The vented gas is therefore flammable and potentially toxic. The vented gas also causes a gas-pressure inside the battery pack to increase.

Safety standards require that, in the case of a serious thermal event (e.g., a thermal run-away occurring in one or more cells of a battery system) triggered by, for example, an internal cell short circuit, no fire or flames arise outside the battery pack for at least 5 minutes after the beginning of the thermal event. However, customers may request that no fire or flames happen at all during a serious thermal event (so-called “Stop Propagation”). Conventionally, cell spacers are used to slow down the propagation from one cell to the next cell. Cell spacers can extend the propagation time to typically about 1 to about 3 minutes. However, cell spacers typically do not stop propagation and only delay it.

Stopping the propagation in the cell stack is difficult due to various factors, including very high costs and packaging space, and likely cannot be achieved using conventional cell spacers.

### SUMMARY

Embodiments of the present disclosure provide a battery system that completely stops (or avoids) thermal propagation across the cells inside the battery system or at least substantially slows (or retards) the thermal propagation when connected to a system providing coolant and to a detection system for detecting a serious thermal event.

Thus, aspects and features of the present disclosure overcome or reduce at least the above-described drawbacks of conventional battery systems and provide: (i) a battery system that completely stops (or prevents) thermal propagation across the cells inside the battery system or at least substantially slows (or retards) the thermal propagation when connected to a system providing coolant and to a detection system for detecting a serious thermal event; (ii) a battery module that completely stops (or prevents) thermal propagation across the cells inside the battery system or at least substantially slows (or retards) the thermal propagation; and (iii) a vehicle including battery systems or battery modules as described above.

The present disclosure is defined by the appended claims and their equivalents. The description that follows is subject to this limitation, and any disclosure lying outside that scope is intended for illustrative as well as comparative purposes.

According to an embodiment of the present disclosure, a battery system includes: a plurality of cell rows; a plurality of cooler beams; and a channel system including a plurality of main channels. Each of the cell rows includes a plurality of cells arranged in a row extending along a first direction. Each of the main channels is configured to guide a coolant. Each of the cells has an essentially prismatic shape formed by a planar front face and a planar rear face, each arranged perpendicular to the first direction, and by a first lateral face, a second lateral face, a bottom face, and a top face. When viewed into the first direction, for each cell, the front side is arranged in front of the rear side. Each of the cell rows is sub-divided into a plurality of blocks, and each of the blocks includes at least one of the cells. Each of the blocks has a front side and a rear side, and, when viewed into the first direction, the front side is formed by the front face of a first one of the cells of the corresponding block and the rear side is formed by the rear face of the last one of the cells of the corresponding block. Each of the cooler beams has a planar first side and a planar second side. Each of the front side and the rear side of the cooler beams is arranged perpendicular to the first direction, and the first side arranged in front of the second side when viewing into the first direction. For each of the blocks, the front side of the corresponding block positively abuts against the second side of one of the cooler beams, and/or the rear side of the corresponding block positively abuts against the first side of another one of the cooler beams. Further, for each of the cooler beams, one of the main channels is integrated in this cooler beam and is thermally connected thereto.

A second embodiment of the present disclosure provides a vehicle including at least one battery system according to the first embodiment.

Further aspects and features of the present disclosure may be learned from the dependent claims or the following description.

### BRIEF DESCRIPTION OF THE DRAWINGS

Aspects and features of the present disclosure will become apparent to those of ordinary skill in the art by describing, in detail, embodiments thereof with reference to the attached drawings, in which:

FIG. 1 is a schematic top view of a first embodiment of a battery system according to the present disclosure;

FIG. 2 is a schematic perspective view a battery cell that can be used in embodiments of the battery system;

FIG. 3 is a schematic top view of a second embodiment of a battery system according to the present disclosure;

FIG. 4 is a schematic top view of a third embodiment of a battery system according to the present disclosure;

FIG. 5A schematically shows a cross-sectional view through a cooler beam in a battery system according to an embodiment of the present disclosure; and

FIG. 5B schematically shows a cross-sectional view through a cooler beam in a battery system according to another embodiment of the present disclosure.

### DETAILED DESCRIPTION

Reference will now be made, in detail, to embodiments, examples of which are illustrated in the accompanying drawings. Aspects and features of the present disclosure, and implementation methods thereof, will be described with reference to the accompanying drawings. The present disclosure may, however, be embodied in various different forms and should not be construed as being limited to the embodiments illustrated herein. Rather, these embodiments are provided as examples so that this disclosure will be thorough and complete, and will fully convey the aspects and features of the present disclosure to those skilled in the art. Accordingly, processes, elements, and techniques that are not considered necessary to those having ordinary skill in the art to have a complete understanding of the aspects and features of the present disclosure may not be described.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of,” when preceding a list of elements, modify the entire list of elements and do not modify the individual elements of the list. As used herein, the terms “use,” “using,” and “used” may be considered synonymous with the terms “utilize,” “utilizing,” and “utilized,” respectively.

As used herein, the term “substantially,” “about,” and similar terms are used as terms of approximation and not as terms of degree, and are intended to account for the inherent deviations in measured or calculated values that would be recognized by those of ordinary skill in the art. Further, if the term “substantially” is used in combination with a feature that could be expressed using a numeric value, the term “substantially” denotes a range of ±5% of the value centered on the value.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

To facilitate the description, a Cartesian coordinate system having x, y, and z axes is provided in at least some of the figures. When present, the terms “upper” and “lower” are defined according to the z-axis. For example, an upper cover is positioned at the upper part of the z-axis, and a lower cover is positioned at the lower part thereof.

The electronic or electric devices and/or any other relevant devices or components according to embodiments of the present disclosure described herein may be implemented utilizing any suitable hardware, firmware (e.g., an application-specific integrated circuit), software, or a combination of software, firmware, and hardware. Further, various components of these devices may be implemented on a flexible printed circuit film, a tape carrier package (TCP), a printed circuit board (PCB), or formed on one substrate. The electrical connections or interconnections described herein may be realized by wires or conducting elements, for example, on a PCB or another kind of circuit carrier. The conducting elements may include metallization (e.g., surface metallizations and/or pins) and/or may include conductive polymers or ceramics. Further, electrical energy might be transmitted via wireless connections, for example, by using electromagnetic radiation and/or light.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present disclosure and should not be interpreted in an idealized or overly formal sense unless expressly so defined herein.

A longitudinally installed cooler (e.g., a cooler beam) may be used to stop thermal propagation from one cell (or battery cell) to the next cell. The cooler beam may be used for standard cell cooling while also acting as an element to stop thermal propagation in the case of a thermal runaway event.

According to an embodiment of the present disclosure, a battery system may include: a plurality of cell rows, each of the cell rows including a plurality of cells arranged in a row extending along a first direction; a plurality of cooler beams; and a channel system including a plurality of main channels, each of the main channels being configured to guide a coolant. Each of the cells may have an essentially prismatic shape confined, with regard to the first direction, by a planar front face and a planar rear face each arranged perpendicular to the first direction. When viewed into the first direction (e.g., in the positive first direction), the front side of each cell is arranged in front of the rear side. The shape of each of the cells may be further confined, with regard to a second direction, by a first lateral face and a second lateral face, and, with regard to a third direction, by a bottom face facing the base portion and a top face. Each of the cell rows may be sub-divided into a plurality of blocks, and each of the blocks includes at least one cell. Each of the blocks has a front side and a rear side, and, when viewed into the first direction, the front side is formed by the front face of the first cell in the corresponding block and the rear side is formed by the rear face of the last cell of the corresponding block. Each of the cooler beams is confined, with regard to the first direction, by a planar first side and a planar second side, and each of the front side and the rear side is arranged perpendicular to the first direction with the first side being arranged in front of the second side when viewing into the first direction. For each of the blocks, the front side of the corresponding block positively abuts against the second side of one of the cooler beams and/or the rear side of the corresponding block positively abuts against the first side of another one of the cooler beams. Further, for each of the cooler beams, one of the main channels is integrated in the corresponding cooler beam and is thermally connected to the corresponding cooler beam.

In such an arrangement, at least one of the front side and the rear side of each block is thermally connected to a first or second side of a cooler beam and, thus, is cooled by the cooler beam when a coolant is guided through the main channel of that cooler beam. Further, due to the thermal insulation of the bottom faces of the cells, heat transfer from cells affected by a thermal event, such as a thermal run-away, to the carrier system (e.g., to base portion of the carrier system) is prevented or at least retarded and/or attenuated.

The first direction, the second direction, and the third direction may be defined with reference to the linear axes of a three-dimensional coordinate system. The coordinate system may be a Cartesian coordinate system. The coordinate system may have a first axis x, a second axis y, and a third axis z. The first direction may point into the direction of the first axis x, the second direction may point into the direction of the second axis y, and the third direction may point into the direction of the third axis z. Then, the term “extending along the first direction” with respect to a certain object or entity may denote that the object or entity extends parallel to the first axis x. This same description may apply to the second direction with regard to the second axis y and to the third direction with regard to the third axis z.

The expression “positively abuts” may denote—with regard to a planar side of a first object and a planar side of a second object—that said planar side of the first object extends along the same plane as said planar side of the second object and that said planar side of the first object and said planar side of the second object at least partially contact each other.

The term “cell” is short for the expression “battery cell.” The term “cell row” refers to a row of battery cells. A row of battery cells could also be referred to as a stack of battery cells. The stack, however, may be intersected; for example, at least one pair of neighboring cells in the stack are spaced apart from each other. The term “block” denotes a “cell block” within a cell row, such as a block of several cells arranged along the first direction. In the present disclosure, the “faces” of a cell are the outer side faces (e.g., outer side surfaces) of the prismatic cell. The expression “essentially prismatic” indicates that on at least one of the six faces thereof (e.g., the terminal face), further members may be arranged, such as electrical harnesses (terminals, etc.). In some embodiments, the cells have an identical shape. Similarly, in some embodiments, the cell rows have the same number of cells. In one embodiment, the cell blocks each include the same number of cells. Each of the blocks may include one cell or each of the blocks may include two cells. The cell rows may be arranged to be spaced apart to each other with respect to the second direction. The term “coolant” refers to a cooling fluid. In some embodiments, each cooler beam intersects each of the cell rows. In each of the cooler beams, the first side is spaced apart from the second side with regard to the first direction. Each of the cooler beams is made of a thermally conductive material or includes a thermally conductive material.

The terms used herein are chosen to facilitate the intelligibility of the explanation and the expressions used therein. For example, the terms “front face,” “rear face,” “top face,” and “bottom face” as well as “front side” and “rear side” are chosen to facilitate the intelligibility of the present disclosure. They are used consistently with the figures and the coordinate system shown in the figures. However, in another orientation of the cell cover, the perspective of the viewer must be accordingly adapted. Expressions like “front face,” “rear face,” “top face,” and “bottom face” as well as “front side” and “rear side” could be replaced by terms like “first face,” “second face,” “third face,” and “fourth face” as well as “first side” (of a block) and “second side” (of a block), respectively, in the following. Such terminology would be fully independent of the spatial orientation of the device, however, the intelligibility may be more difficult.

For each of the cells, a first terminal and a second terminal may be arranged on the top face of the cell. However, in other embodiments, for each of the cells, the first and/or the second terminal may be arranged on the bottom face of the cell or on one of its lateral faces.

The bottom face and/or the top face of a cell may have a planar shape or essentially (or substantially) planar shape. Then, with reference to the above-defined coordinate system, the bottom face and/or the top face may extend parallel to the x-y-plane. The first lateral face and/or the second lateral face may have a planar shape or essentially planar shape. Then, the bottom face and/or the top face may extend parallel to the x-z-plane of the coordinate system. Further, the front face and the top face may each extend parallel to the y-z-plane of the coordinate system. Also, the base portion may have a planar shape or an essentially planar shape. The base portion may extend parallel to the x-y-plane of the coordinate system.

In the cooler beams, the integrated main channels may be in thermal contact with (or in thermal contact to) at least one of the first side or the second side of the respective cooler beam. In some or all of the cooler beams, the integrated main channels may be in thermal contact with the first side and the second side of the respective cooler beam. In at least some of the cooler beams (e.g., in the first cooler beam and/or the last cooler beam when viewed into the first direction), the integrated main channels may be in thermal contact with only one of the first side and the second side of the respective cooler beam.

Because the cell rows each extend along the first direction, the cell rows are arranged in parallel to each other. Further, the cell rows may be lined up along the second direction; in other words, the cell rows are juxtaposed to one another (or are adjacent to each other) along the second direction.

A main channel (system) may include a single channel or pipe or, in other embodiments, may include a plurality of (sub-)channels or pipes. In the latter embodiments, each of main channels may be generally referred to as a main channel system. For the sake of simplicity, the term “main channel” will be used throughout the present disclosure, even to describe embodiments in which a main channel includes a plurality of (sub-)channels or pipes.

In one embodiment of the battery system, the battery system further includes a carrier framework having a base portion, and each of the cell is arranged to be thermally insulated from the base portion.

The base portion may have a plate-like shape extending essentially perpendicular to the third direction. Further, for each cell, the bottom face may face to the base portion. The bottom face of the cell is thermally insulated from the base portion.

In one embodiment of the battery system, each of the front face and the rear face of a cell has a larger area than each of the first lateral face and the second lateral face of this cell.

Any cell abutting a cooler beam contacts the cooler beam with its large side face, which provides maximum heat exchange between this cell and the adjacent cooler beam. When the cooler beam is cooled by a coolant flowing through the main channels system integrated therein, the cell is optimally cooled because the heat can be discharged from the cell through a large area to the coolant.

In one embodiment of the battery system, for any two cells arranged adjacent to each other in the second direction, the lateral side of one of these cells facing a lateral side of the other one of these cells is thermally insulated from this lateral side of the other one of these cells.

For example, any two cells arranged adjacent to each other in the second direction are thermally insulated from each other. In the event of a thermal event occurring in one of the cells, such thermal insulation helps to avoid or at least to retard and/or to attenuate the propagation of heat from the cell affected by the thermal event to the neighboring cell or cells in the second direction. In more detail, in the event of a thermal run-away occurring in one cell, heat propagation to the cells neighboring the affected cell in the second direction are avoided or at least retarded and/or attenuated.

In one embodiment of the battery system, the thermal insulation of each of the cells to the base portion is provided by an air gap or at least a partial air gap and/or includes an insulation layer.

In one embodiment of the battery system, the thermal insulation between any two cells arranged adjacent to each other with respect to the second direction is formed by an air gap or at least a partial air gap and/or includes an insulation layer.

Optimal thermal insulation of the lateral faces of the cells as well as of bottom face of the cells is provided by this thermal insulation. In some embodiments, the thermal insulation is provided by an air gap. If, however, contact between two components cannot be fully avoided to be thermally insulated from each other (e.g., due to mechanical connections required for the sake of mechanical stability), the contact may be reduced to a minimum. However, layers including materials having a rather low heat conductivity may also be included to achieve excellent thermal insulation.

In some embodiments, the front side of each intermediate block positively abuts against the second side of one of the cooler beams, and the rear side of each intermediate block positively abuts against the first side of another one of the cooler beams. Here and in the following disclosure, the term “intermediate block” refers to any block other than the first block and the last block of a cell row with regard to the first direction (i.e., when viewed in the first direction). Further, the term “end block” shall refer to each of the first block and last block in a cell row with regard to the first direction (or, equivalently, to any block that is not an intermediate block as defined above).

In some embodiments, all blocks have the same dimension with regard to the first direction (in other words, all blocks have the same size when measured along the first direction). In one embodiment, all blocks comprise the same number of cells. In preferred embodiment, all cells are identically shaped.

In one embodiment of the battery system, each of the cooler beams positively abuts one of the front side and the rear side of at least one block of each cell row.

In various embodiments, each of the intermediate cooler beams is arranged such that both its first and second sides are intersected by a longitudinal center axis of each of the cell rows. Here and in the following disclosure, the term “intermediate cooler beam” refers to any cooler beam arranged between two blocks with regard to the first direction. Further, the term “end cooler beam” shall refer to any one of the first cooler beam and the last cooler beam with regard to the first direction.

In one embodiment, each of the cooler beams—except for the end cooler beams—positively abuts one of the rear side of one block of each cell row and the front side of the next block (with regard to the first direction) of that cell row.

In one embodiment, the first cooler beam (with regard to the first direction) positively abuts (with its second side) against the front side of the first blocks of each cell row. Further, in one embodiment, the last cooler beam (with regard to the first direction) positively abuts (with its first side) against the rear side of the last blocks of each cell row.

In one embodiment of the battery system, all cell rows include (or have) the same number of blocks. Further, when viewing into the first direction, for each of the cell rows, the rear side of the first block positively abuts the first side of one of the cooler beams and the front side of the last block positively abuts the second side of one of the cooler beams. For each block being arranged, in one of the cell rows, between the first block and the last of the corresponding cell row when viewing into the first direction, the front side of that block positively abuts the second side of one of the cooler beams and the rear side of that block positively abuts the first side of one of the cooler beams.

In various embodiments, each intermediate block abuts, with its front side, a cooler beam and, with its rear side, another cooler beam. Thus, when coolant is guided through the main channels and, thus, through the beams, each intermediate block is cooled at its front side and its rear side. Further, any one of the end blocks abuts with at least one of its front side and its rear side to a cooler beam. Thus, when coolant is guided through the main channels and, thus, through the beams, each end block is cooled at least at one of its front side and its rear side.

With regard to the first direction, the first cooler beam is arranged in front of each of the first blocks, and the front side of each first block positively abuts the second side of the first cooler beam. With regard to the first direction, the last cooler beam is arranged behind of each of the last blocks, and the rear side of each last block positively abuts the first side of the last cooler beam. Thus, when coolant is guided through the main channels and, thus, through the beams, each end block is cooled at its front side and at its rear side.

For any two neighboring cooler beams with regard to the first direction (i.e., for any two cooler beams arranged consecutively along the first direction), the cells arranged between these two neighboring cooler beams may be grouped together into one group (cell group), and the cells of this group may be electrically connected to one another. For each cell, the first terminal may be a negative terminal, and the second terminal may be a positive terminal. In other embodiments, however, the first terminal may be a positive terminal, and the second terminal may be a negative terminal. Then, in either embodiment, for each of the groups, an order (sequence) of the cells may be defined (e.g., chosen) such that the cells in the group are ordered from a first cell to a last cell, and the second terminal of each cell in the group—except for the last cell in the group—may be connected to the first terminal of the next cell in the group according to the chosen numbering. Then, each terminal of any cell in the group is connected to another cell in the group except for the first terminal of the first cell and the second terminal of the last cell. Further, the first terminal of the first cell in the group may be connected to a second terminal of the last cell of another group or may act as a first terminal for the battery system (e.g., as a first final terminal). Also, the second terminal of the last cell in the group may be connected to a first terminal of the first cell of another group or may act as a second terminal for the battery system (e.g., as a second final terminal). Accordingly, a cell group may be connected to another cell group with only one electrical connector. Thus, any two cell groups neighboring each other with regard to the first direction (but separated from each other by a cooler beam) may be electrically connected to each other by using a single electrical connector, such as a busbar, which is arranged such that it is thermally connected to the cooler beam between these neighboring cell groups. For example, the electrical connector may abut a top side or a bottom side of the cooler beam. In other embodiments, the electrical connector may pass through the cooler beam. In such an embodiment, the electrical connector should be electrically separated (or isolated) from the main channel integrated in the respective cooler beam.

Because cells of different cell rows are formed in one group, the cells between any two neighboring cooler beams are electrically connected to each other across the cell rows. The connections between the cells may be provided by busbars.

In one embodiment of the battery system, each block includes at most two cells.

In one embodiment of the battery system, each block includes a single cell.

For example, in one embodiment, in any cell row, the number of cells in each block of the cell row equals one or two. In an embodiment, in any cell row, the number of cells in each block of the cell row equals two. Further, in another embodiment, in any cell row, the number of cells in each block of the cell row equals one.

In one embodiment of the battery system, each of the first and second sides of the blocks that positively abuts against a cooler beam is mechanically fixated to the respective cooler beam. For example, the first or second side of a block may be adhered to the respective cooler beam.

In one embodiment of the battery system, each of the first and second sides of the cells that positively abuts against another cell is mechanically fixed (or fixated) to the respective cooler beam. For example, the first or second side of a cell may be adhered to the other cell.

The cooler beams may each include a mechanically stable material. The cooler beams may each include a thermally conductive material. The cooler beams may each be made of steel or may include steel.

In one embodiment of the battery system, each of the cooler beams includes a pipe extending along the second direction. Further, the pipe may have a first planar side portion forming, at the exterior surface thereof, the first planar side of the cooler beam that includes the pipe. Also, the pipe has a second planar side portion forming, at the exterior surface thereof, the second planar side of the cooler beam that includes the pipe.

In some embodiments, the main channels system integrated into a beam are formed by the respective pipe. The pipes may each have a bottom portion and a top portion (with respect to the third direction). The top portion connects (or extends between) the first and second side portions in a top area to each other (e.g., the top portion connects the upper edges of the first and second side portions with each other). The bottom portion connects the first and second side portions in a lower area to each other (e.g., the bottom portion connects the lower edges of the first and second side portions with each other). Each of the bottom and the top portion of the pipe may have a planar exterior surface.

In one embodiment of the battery system, each of the cooler beams includes an aluminum cooler core arranged between two thermally insulating layers. The thermally insulating layers may be mica layers.

In one embodiment of the battery system, the aluminum cooler core has a first wall and a second wall, and the first and second wall each extend along the second direction and are arranged opposite to each other with regard to the first direction. When viewed in the first direction, the first wall is arranged in front of the second wall.

The first wall may have a planar side facing against the first direction, and this planar side may form the first planar side of the cooler beam that includes the aluminum cooler core. Correspondingly, the second wall may have a planar side facing into the first direction, and this planar side may form the second planar side of the cooler beam that includes the aluminum cooler core.

In one embodiment of the battery system, for each of the cooler beams, the main channel integrated into this beam includes: at least one or more first cooling pipes each extending along the second direction and arranged on a side of the first wall facing the second wall; and at least one or more second cooling pipes each extending along the second direction and arranged on a side of the second wall facing the first wall.

For example, one or more cooling pipes are arranged on each of the inner sides of the walls of the aluminum cooler core. The cooling pipes each allow for guiding a coolant near to the inner sides of the walls. The cooling pipes may be made of aluminum. The cooling pipes may be directly connected or fixated to the inner sides of the walls by, for example, welding. This provides good heat transfer between the walls and a coolant flowing in the cooling pipes.

In a main channel according to some embodiments, the number of first cooling pipes may be equal to the number of second cooling pipes. The main channel may include a number of pairs, and each pair includes one first and one second cooling pipe. In each pair, the first and second cooling pipe may be arranged opposite to each other, for example, a longitudinal center axis of the first cooling pipe of that pair and a longitudinal center axis of the second cooling pipe of that pair may be arranged in a same plane being parallel to the x-y-plane of the above-defined coordinate system.

In one embodiment of the battery system, the first wall and the second wall are connected to each other by rods or ribs, and each of the rods or ribs extends between one of the first cooling pipes and one of the second cooling pipes.

Thereby, each of the rods or ribs extends between a portion of a first cooling pipe facing the second wall and a portion of a second cooling pipe facing the first wall.

In an embodiment, the rods have each an elongated shape extending parallel to the first direction. In one embodiment, the ribs have each a planar shape extending parallel to the first direction and parallel to the second direction.

In an embodiment of the battery system, for any two blocks that are separated from each other by one of the cooler beams and are electrically connected to each other by an electrical connector, the electrical connector is thermally connected to the cooler beam that separates these blocks.

The electrical connector may be a wire or a busbar. The wire or busbar may be attached to a top side or a bottom side of the cooler beam separating the blocks that are electrically connected to each other by this wire or busbar. In other embodiments, this wire or busbar may pass through the cooler beam. In such an embodiment, of course, the wire or busbar should be electrically separated from the main channel integrated in the respective cooler beam.

In some embodiments, each of the main channels includes an inlet and an outlet. In various embodiments, some or all of the main channels each include a plurality of (sub-)channels or pipes, and the inlet of a respective main channel may be configured to supply each of the (sub-)channels or pipes of that main channel with a coolant supplied into the inlet, and, correspondingly, the outlet of a respective main channel may be configured to discharge the coolant received from each of the (sub-)channels or pipes of that main channel.

In one embodiment, the battery system further includes a coolant supply channel and a coolant discharge channel. The inlet of each main channel is connected with (or is in fluid communication with) the coolant supply channel and an outlet of main channel system is connected with the coolant discharge channel. Then, each of the main channels may be supplied with coolant from the supply channel, and each of the main channels may discharge coolant into the discharge channel. For example, the main channels may be considered as being connected in parallel within the channel system. The supply channel may include an inlet configured to be connected to a supply for a cooling system. The discharge channel may include an outlet to be connected to a coolant receiver of a cooling system configured to receive discharged coolant. The supply channel and the discharge channel may be members of the channel system of the battery system.

In one embodiment, when viewing into the first direction, the outlet of each main channel—except for the last main channel—is connected with the inlet of the next main channel (e.g., the following main channel with regard to the first direction) via a connection channel. Thus, coolant supplied into the inlet of the first main channel will consecutively flow through each of the following main channels. After having passed through the last main channel, the coolant will be discharged by (or through) the outlet of the last main channel. Thus, the main channels may be considered as being connected in series within the channel system.

The inlet of the first main channel may be configured to be connected to the supply of a cooling system. The outlet of the last main channel may be configured to be connected to a coolant receiver of a cooling system configured to receive discharged coolant.

Further, the inlets and outlets of the main channels may be arranged such that at the ends of the main channels pointing against the second direction (e.g., pointing opposite to the second direction), inlets and outlets are arranged in an alternating manner when viewed into the first direction. Then, inlets and outlets are arranged in an alternating manner when viewed into the first direction and are also at the ends of the main channels pointing into the second direction. The connection channels may each be members of the channel system of the battery system. Thus, in such embodiments, the channel system has a meandering shape.

In each of the described aspects and embodiments, the roles of the “outlets” and “inlets” can be switched, that is, any “inlet” can be regarded as an “outlet” and any “outlet” regarded as an “inlet” in the above description. The above-described topologies of the channel system (e.g., the described possibilities and how the various channels in the channel system may be connected with each other irrespectively of the special geometric design) are not affected by such a switch. However, if applicable, the roles of the supply channel and the discharge channel of the battery system may have to be suitably exchanged (or reversed).

In one embodiment, the battery system includes: a cooling system configured to be activated and deactivated; a battery management unit (BMU); and a detection system configured to detect, for some or all of the cells, whether or not a thermal event occurs in the cell. The detection system is further configured to send a signal to the battery management unit when a thermal event has been detected. Further, the battery management unit is configured to receive a signal from the detection system and to activate the cooling system upon receiving a signal from the detection system. The cooling system is further configured to supply, when activated, each of the main channels with a coolant.

The thermal event may be, for example, a thermal run-away. The thermal event may be defined by meeting or exceeding a threshold temperature value (e.g., a predetermined or set threshold temperature value). The detection of a thermal event may occur by detecting whether or not the temperature of a cell in the battery system exceeds the threshold temperature value.

A second embodiment of the present disclosure provides a vehicle comprising at least one battery system as described above.

In the vehicle, the battery system may be arranged such that the cooler beams extend perpendicular or essentially perpendicular to the normal driving direction of the vehicle. For example, the cooler beam may each be configured as cross beams. However, in other embodiments, the cooler beams may each be configured, for example, as longitudinal beams.

In some embodiments, the cooler beams are arranged relative to the blocks with regard to the third direction such that, for each of the blocks, the complete front side of that block positively abuts against the second side of one of the cooler beams and/or the complete rear side of that block positively abuts against the first side of another one of the cooler beams. Thus, maximum mechanical contact between the respective front or rear side of a block and the cooler beam against which the side positively abuts is established and, as a consequence thereof, maximum heat transfer between the respective front or rear side of a block and the cooler beam against which the side positively abuts may occur.

Generally, some of the aspects and features of embodiments may be summarized as follows. Instead of conventional cooling provided at the bottom of the cells, the cooler beams are installed to intersect (or cross) the cell rows. For example, after every cell or every two cells, a thin cooler beam crosses each or at least some of the cell rows. Accordingly, a certain number or even each of the cells can be cooled at one of the large (or long) sides. In the event of a thermal run-away occurring in one (or more) of cells, the thermal run-away will be detected by the BMU, which is connected as an external device to the battery system or is integrated in the battery system, and will wake up the vehicle and demand (e.g., enable or active) active cooling. The active cooling will help to transport away the produced energy from the cell affected by the thermal run-away and will protect the neighboring cell in the cell row. The long side of the cell has the highest thermal conductivity to the internal anode/cathode stack or jelly rolls and has the biggest surface area. The small sides and the bottom of the cell shall are, as much as possible, isolated from other mechanical structures by, for example, air or minimal contact therebetween. The cells may be mechanically connected to the cooler, which may also act as a mechanical cross beam.

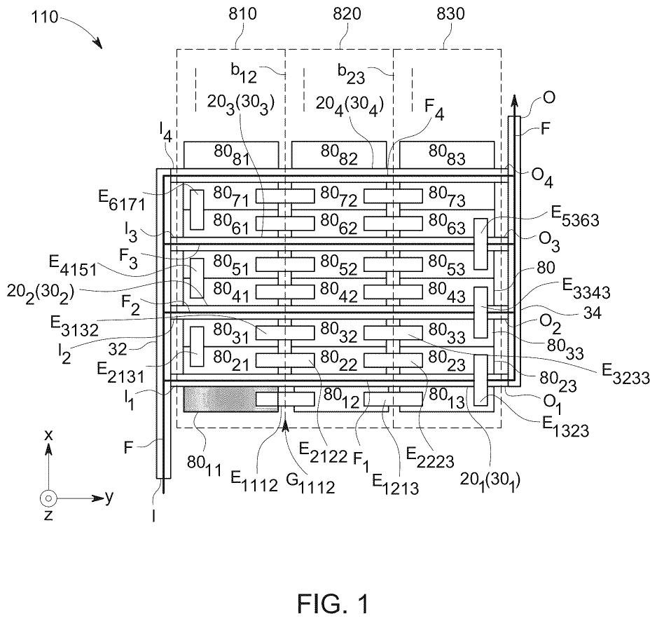

FIG. 1 is a schematic top view on an embodiment of battery system with a housing omitted for ease of description. To facilitate the description, a Cartesian coordinate system with x, y, and z axes is included in FIG. 1. The x-y-plane is identical with the drawing plane of the figure, and the z-axis is orientated perpendicular to the drawing plane.

In the illustrated embodiment, the battery system 110 has three battery cell rows (in the following simply referred to as “cell rows”). The battery system 110 has a first cell row 810, a second cell row 820, and a third cell row 830. Each of the cell rows 810, 820, 830 extends in a direction parallel to the x-direction of the coordinate system, as schematically indicated by the rectangles with the dashed borders. The outer shape of all battery cells is identical. The first cell row 810 includes a plurality of cells 80ᵢ₁ with the index i∈{1, 2, 3, 4, 5, 6, 7, 8}. Also, the second cell row 820 includes a plurality of cells 80ᵢ₂ with the index i∈ {1, 2, 3, 4, 5, 6, 7, 8}. Similarly, the third row 830 includes a plurality of cells 80ᵢ₃ with the with the index i∈{1, 2, 3, 4, 5, 6, 7, 8}. However, each of the cell rows 810, 820, 830 may include more or fewer battery cells (in the following also simply referred to as “cells”) than depicted in FIG. 1. For example, additional cells may be arranged in each of the cell rows 810, 820, 830, behind the respective last cells 80₈₁, 80₈₂, 80₈₃ when viewing into the x-direction. This is indicated by the dashed lines in the upper left portion of the dashed rectangles.

Cells of the first cell row 810, the second cell row 820, and the third cell row 830 are lined up, side by side, along the y-direction with their respective lateral sides facing each other. Accordingly, each cell 80ᵢⱼ can be identified by its position with regard to the x-direction (by the first index i of the reference sign 80ᵢⱼ indicating the cell's position in the respective cell row, when viewing into the x-direction) and with regard to the y-direction (by the second index j of the reference sign 80ᵢⱼ indicating the cell row including the cell, with the cell rows being counted along the y-direction).

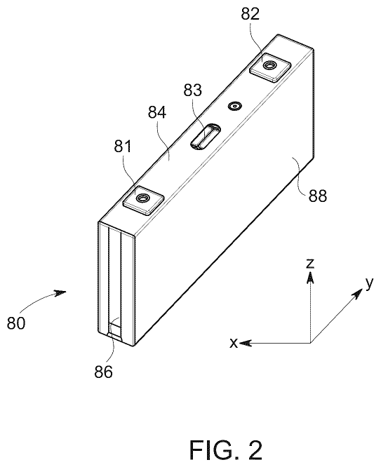

One embodiment of the battery cells that may be included in the battery system is schematically illustrated in FIG. 2. In FIG. 2, an individual battery cell 80 is illustrated with reference to a Cartesian coordinate system in a perspective view. The battery cell 80 could be any one of the identically shaped cells 80ᵢⱼ (i∈{1, 2, 3, 4, 5, 6, 7, 8}, j∈{1, 2, 3}) in the battery system 110 shown in FIG. 1, as described above. The battery cell 80 has a prismatic (cuboid) shape. Hence, the battery cell 80 has six side faces: a top face 84 arranged opposite, with regard to the cell's body, to a bottom face, a first lateral face 86 and a second lateral face arranged opposite to the first lateral face, as well as a front face 88 arranged opposite to a rear face. Each of the side faces has an essentially planar shape. As can be seen in FIG. 2, the area (e.g., the surface area) of the front face 88 (and the rear face, which is essentially congruent to the front face 88) is larger than any one of the top face 84 and the first lateral face 86 (and thus, the front face 88 is also larger than any one of the second lateral face, which is congruent to the first lateral face 86, and the bottom face, which is congruent to the top face 84).

On the top face 84 of the battery cell 80 (e.g., the battery cell's side surface facing into the z-direction of the coordinate system), a first terminal 81 and a second terminal 82 are arranged. The terminals 81, 82 allow for an electrical connection with the battery cell 80. The first terminal 81 may be the negative terminal of the battery cell 80, and the second terminal 82 may be the positive terminal of the battery cell 80. Accordingly, the top face 84 may be also referred to below as the “terminal side” of battery cell 80. Between the first terminal 81 and the second terminal 82 in the terminal side 84, a venting outlet 83 may be arranged. The venting outlet 83 is configured to exhaust vent gases from the battery cell 80, which may be generated inside the battery cell 80 during, for example, a thermal event occurring in the battery cell 80, such as a thermal run-away. Before being exhausted via the venting outlet 83, the vent gas may pass through a venting valve arranged inside the battery cell 80. By stacking a plurality of battery cells, each being configured similar to the battery cell 80 shown in FIG. 2, along the x-direction, a stack of battery cells is created, such as any one of the three stacks shown in FIG. 1. Accordingly, each of the cells 80ᵢⱼ shown in FIG. 1 may be orientated as indicated by the coordinate system of FIG. 2, for example, the front face of each cell 80ᵢⱼ faces against the x-direction, the rear face of each cell 80ᵢⱼ faces into the x-direction, the first lateral face of each cell 80ᵢⱼ faces against the y-direction, the second lateral face of each cell 80ᵢⱼ faces into the y-direction, the bottom face of each cell 80ᵢⱼ faces against the z-direction, and the top face of each cell 80ᵢⱼ faces into the z-direction.

In the battery system 110 shown in FIG. 1, a plurality of cooler beams is arranged. The cooler beams include a first cooler beam 20₁, a second cooler beam 20₂, a third cooler beam 20₃, and a fourth cooler beam 20₄ arranged in sequence along the x-direction and each extending along the y-direction. Each of the cooler beams 20₁, 20₂, 20₃, 20₄ has a planar first side perpendicular to the drawing plane (e.g., parallel to the y-z-plane of the coordinate system) and facing against the x-direction as well as a planar second side being perpendicular to the drawing plane but facing into the x-direction. Accordingly, each of the first and second side of each of the cooler beams 20₁, 20₂, 20₃, 20₄ is arranged parallel to each of the front and rear face of each of the cells 80ᵢⱼ in the battery system 110.

Further, each of the cooler beams 20₁, 20₂, 20₃, 20₄ intersects (or crosses) each of the cell rows 810, 820, 830. For example, the cell rows 810, 820, 830 are intersected by the first cooler beam 20₁ such that, in each of the cell rows 810, 820, 830, the respective first cell 80₁₁, 80₁₂, 80₁₃ is separated, along the x-direction, from the respective second cell 80₂₁, 80₂₂, 80₂₃. Similarly, the cell rows 810, 820, 830 are intersected by the k-th cooler beam 20ₖ (with k∈{2, 3, 4}) such that, in each of the cell rows 810, 820, 830, the respective (2k-1)-th cell 80_{(2k-1),1}, 80_{(2k-1),2}, 80_{(2k-1),3} is separated, along the x-direction, from the respective subsequent (2k)-th cell 80_{(2k),1}, 80_{(2k),2}, 80_{(2k),3} (the first and second indices in the reference sign indicating the cells being separated here by a comma to avoid a misinterpretation, in particular a confusion with multiplication). This scheme may apply correspondingly for further cooler beams and cells that may be arranged, in the x-direction, behind the cells 80₈₁, 80₈₂, 80₈₃ (e.g., behind the last cells shown in the figure).

Due to the afore-described arrangement, each of the cell rows 810, 820, 830 is split into several cell blocks (in the following also referred to as “blocks”). For example, with respect to the cells shown in FIG. 1, the first cell row 810 is split into a first cell block including the only cell 80₁₁, a second cell block including two cells 80₂₁ and 80₃₁, a third cell block including two cells 80₄₁ and 80₅₁, a fourth cell block including two cells 80₆₁ and 80₇₁, and a fifth cell block (e.g., last cell block shown in FIG. 1 for the first cell row 810) including only one cell 80₈₁. As can be further seen from FIG. 1, the second cell row 820 and the third cell row 830 are each split by the cooler beams 20₁, 20₂, 20₃, 20₄ in a corresponding manner.

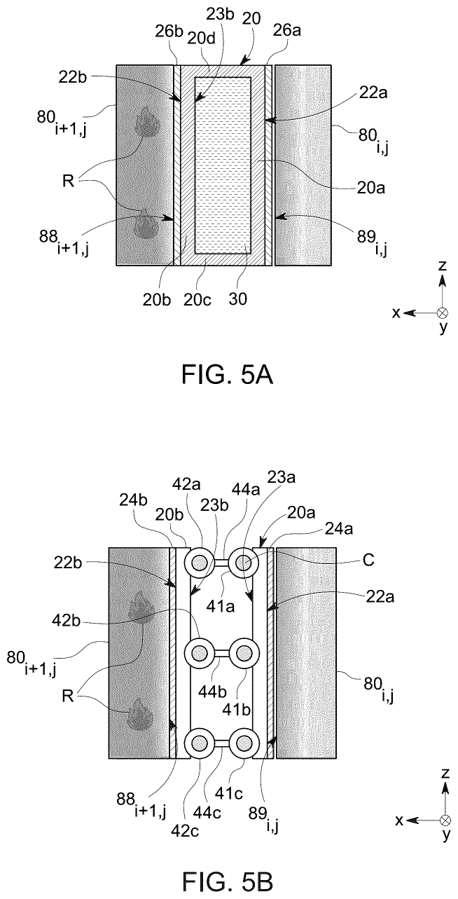

As can be further seen in FIG. 1, each of the intermediate blocks (e.g., each block other than the first block and the last block of each cell row 810, 820, 830) positively abuts with its front side (formed by the front face of the first cell in the respective block with respect to the x-direction) against the second side of one of the cooler beams 20₁, 20₂, 20₃, 20₄, and similarly, positively abuts with its rear side (formed by the rear face of the last (second) cell in the respective block with respect to the x-direction) against the first side of another one of the cooler beams 20₁, 20₂, 20₃, 20₄. Due to the above-described arrangement of the cells 80ᵢⱼ and the cooler beams 20₁, 20₂, 20₃, 20₄, each of the intermediate blocks includes exactly two cells. Further, each of these two cells positively abuts with one of its front or rear face against one of the cooler beams 20₁, 20₂, 20₃, 20₄ and, thus, can be cooled by the abutting cooler beam when the cooler beam has a lower temperature than the cell. This can be achieved by cooling the cooler beams 20₁, 20₂, 20₃, 20₄ with a coolant guided through the cooler beams 20₁, 20₂, 20₃, 20₄, as will be described later with reference to FIGS. 5A and 5B.

Different from the intermediate blocks (e.g., the second, third, and fourth blocks of each of the cell rows 810, 820, 830), the first blocks (with regard to the x-direction) of each of the cell rows 810, 820, 830 each include only a single battery cell 80₁₁, 80₁₂, 80₁₃. As can be seen in FIG. 1, each of these battery cells 80₁₁, 80₁₂, 80₁₃ positively abuts, with its respective rear face, against the first side of the first cooler beam 20₁. Hence, each of these cells 80₁₁, 80₁₂, 80₁₃ can be cooled by the first cooler beam 20₁ when the first cooler beam 20₁ has a lower temperature than the cell. With regard to the cells shown in FIG. 1, this applies in a similar manner to the last depicted blocks; that is, each of these battery cells 80₈₁, 80₈₂, 80₈₃ positively abuts, with its respective front face, against the second side of the fourth cooler beam 20₄. Thus, each of these cells 80₈₁, 80₈₂, 80₈₃ can be cooled by the fourth cooler beam 20₄ when the fourth cooler beam 20₄ has a lower temperature than the cell.

To achieve maximum heat exchange between a cooler beam and an abutting cell, tight mechanical contact between the cooler beam and the cell should be provided in the area at where the cooler beam abuts the cell. Thus, the cell can be mechanically affixed to the cooler beam with the front or rear face, with which the cell positively abuts against the first or second side of the cooler beam. The mechanical fixation can be achieved, for example, by using an adhesive.

As already described above with reference to FIG. 2, the front face and the rear face of each cell are the cell's side faces having the largest areas in comparison to any one of the top and bottom faces as well as the first and second lateral face. Because, as described before with reference to FIG. 1, either the front face or the rear face of each cell 80ᵢⱼ abuts one of the cooler beams 20₁, 20₂, 20₃, 20₄, a relatively large area is provided for the heat exchange between the cell and the abutting cooler beam, which provides for excellent cooling of the cell when the cooler beam has a lower temperature than the cell.

Heat exchange between the cells 80ᵢⱼ and parts of the battery system other than the cooler beams, such as a casing or housing, should be kept as low as possible. For example, as already described above in the introductory part, flames should be contained within the battery system as much as possible. Accordingly, all other side faces than the front face and the rear face should be thermally insulated from the environment for each of the cells 80ᵢⱼ.

To that end, between any two cells that neighbor each other with regard to the y-direction, a space or an airgap may be provided. Accordingly, in the embodiment of the battery system 110 shown in FIG. 1, the complete cell rows 810, 820, 830 are arranged to be spaced apart from each other with regard to the y-direction. The spaces or air-gaps are arranged between the cells 80ᵢⱼ (i∈{1, 2, . . . , 8}) of the first cell row 810 and the respective opposite cells 80ᵢ₂ (i∈{1, 2, . . . , 8}) of the second cell row 820 in the area indicated by the dashed line b₁₂, and, correspondingly, between the cells 80ᵢ₂ (i∈{1, 2, . . . , 8}) of the second cell row 820 and the respective opposite cells 80ᵢ₃ (i∈{1, 2, . . . , 8}) of the third cell row 830 indicated by the dashed line b₂₃. For example, the cell 80₁₁ shown at the left bottom corner in the top-view of FIG. 1 is separated by the adjacent cell 80₁₂ by a space or air-gap G₁₁₁₂.

The battery system 110 may be arranged on a carrier framework including a base portion that supports the cells 80ᵢⱼ as well as the cooler beams and, in some embodiments, other equipment of the battery system 110. Accordingly, the cells 80ᵢⱼ are each separated from the base portion by a space or an airgap. However, to provide mechanical stability, stilts may be arranged protruding from the base portion into the z-direction, and the stilts may be connected mechanically to the bottom faces of the cells 80ᵢⱼ. Thus, the mechanical connections between the bottom faces of the cells 80ᵢⱼ and the base portion are reduced, and thus, also heat exchange between the cells 80ᵢⱼ and the base portion is reduced or minimized.

When the battery system is arranged in a housing having a cover arranged above the cells 80ᵢⱼ with regard to the z-direction, the cover should be positioned to have a distance to (e.g., to be spaced apart from) the top sides of each of the cells 80ᵢⱼ. This applies in a similar manner to the front faces of the first cells 80₁₁, 80₁₂, 80₁₃ of the cell rows 810, 820, 830 as well as to the rear faces of the last cells of each of the cell rows 810, 820, 830 with regard to the side walls of the housing when no cooler beam is arranged between these faces and the respective adjacent side wall of the housing.

In a battery system, the cells are electrically interconnected to each other. For example, the cells may be connected to each other in series and/or in parallel. In some embodiments, several clusters of cells may be formed (e.g., the cells of each stack of battery cells may form one cluster) within the battery system, and the cells of each cluster may be connected to each other in series. The clusters may be connected to each other in parallel. In the battery system 110 shown in FIG. 1, the cells 80ᵢⱼ are connected in series. The electrical connection is established by busbars, such as the busbar E₁₁₁₂, electrically connecting the cell 80₁₁ in left bottom corner in the top-view of FIG. 1 with the cell 80₁₂ arranged next to it with regard to the y-direction.

However, because an electrical connector is often made of metal, each of the busbars may cause undesired heat transfer between any two connected cells, or even, when the connected cells are arranged on different sides of a cooler beam, may cause unwanted heat exchange between different cell blocks across the cooler beam, thereby deteriorating the effect of the cooler beam as a heat barrier between the cell blocks arranged on its different sides. Hence, the number of electric connectors between cells arranged on different sides of a cooler beam should be minimized, for example, at least for the series connection of the cells 80ᵢⱼ of the battery system 110 is reduced to 1. This can be achieved by an arrangement of the electrical connectors (busbars) as shown in FIG. 1 and described below.

Due to the before-described arrangement of the cooler beams 20₁, 20₂, 20₃, 20₄, the cells 80ᵢⱼ are assembled in several groups. A first group may include any cell 80₁₁, 80₁₂, 80₁₃ arranged, when viewed into the x-direction, in front of the first cooler beam 20₁. For example, the first group includes the first blocks of each of the cell rows 810, 820, 830. Further, a second group may include any cell 80₂₁, 80₂₂, 80₂₃, 80₃₁, 80₃₂, 80₃₃ being arranged, when viewed into the x-direction, between the first cooler beam 20₁ and the second cooler beam 20₂. For example, the second group includes the second block of each of the cell rows 810, 820, 830. The remaining groups are defined in a corresponding manner; for example, a third group includes the cells 80₄₁, 80₄₂, 80₄₃, 80₅₁, 80₅₂, 80₅₃ that are arranged between the second cooler beam 20₂ and the third cooler beam 20₃, and a fourth group includes the cells 80₆₁, 80₆₂, 80₆₃, 80₇₁, 80₇₂, 80₇₃ that are arranged between the third cooler beam 20₃ and the fourth cooler beam 20₄.

The cells of each group may be electrically connected with each other in series. For example, because each of the cells includes a first terminal (e.g., a negative terminal) and the second terminal (e.g., a positive terminal), the second terminal of each of the cells in a group—except for one cell—may be connected with a first terminal of another cell (e.g., an adjacent cell). For example, with reference to FIG. 1, the cell 80₁₁ in the first group is connected to the adjacent cell 80₂ in the first group by a busbar E₁₁₁₂, and the latter cell 80₁₂ is connected, in turn, with the next cell 80₁₃ (with respect to the y-direction) in the first group by another busbar E₁₂₁₃. Further, from among the cells 80₂₃, 80₂₂, 80₂₁, 80₃₁, 80₃₂, 80₃₃ of the second group, any two subsequent cells with regard to the order as described above are connected in series by respective busbars E₂₂₂₃, E₂₁₂₂, E₂₁₃₁, E₃₁₃₂, and E₃₂₃₃. This applies in a corresponding manner to any of the further groups. Thus, for the electric connectors within each of the groups, no electric connection must cross one of the cooler beams 20₁, 20₂, 20₃, 20₄. However, in each group, there is one cell with an unconnected first terminal, which may act as the first terminal of this group, and there is also another cell with an unconnected second terminal, which may act as the second terminal of this group. The first terminal of the first group may act as a first terminal (e.g., a first final terminal) of the complete battery system 110, and the second terminal of the last group may act as a second terminal (e.g., a second final terminal) of the complete battery system 110. Further, the second terminal of each group—except for the last group—may be connected to the first terminal of the subsequent group with regard to the x-direction. Thus, only the last-mentioned connectors need to cross one of the cooler beams. For example, the rightmost cell 80ᵢ₃ of the first group is connected, via the busbar E₁₃₂₃ arranged across the first cooler beam 20₁, with the cell 80₂₃ in the bottom right corner of the second group. Further, the cell 80₃₃ in the upper right corner of the second group is connected, via the busbar E₃₃₄₃ arranged across the second cooler beam 20₂, with the cell 80₄₃ in the bottom right corner of the third group, and the cell 80₅₃ in the upper right corner of the third group is connected, via the busbar E₅₃₆₃ arranged across the third cooler beam 20₃ with the cell 80₆₃ in the bottom right corner of the fourth group. This way of electrically connecting the individual groups to each other can be continued in a corresponding manner for each of the further groups in the battery system 110. Then, for each cooler beam, there is only one electric connectors (e.g., the one busbar) arranged across the cooler beam. Hence, heat transfer between different groups—and thus, the risk for the propagation or spreading of thermal events across the cells—via the electrical connectors is minimized.

The cooler beams 20₁, 20₂, 20₃, 20₄ may provide and/or increase mechanical stability of the battery system 110. The cooler beams 20₁, 20₂, 20₃, 20₄ should be configured to resist the pressure arising within the cell rows 810, 820, 830 not only in case of thermal events but also due to swelling processes during normal operation of the battery system 110. However, the primary function (or purpose) of the cooler beams 20₁, 20₂, 20₃, 20₄ according to embodiments the present disclosure is their ability to cool the battery system 110 by cooling the battery cells that directly abut against (one or two of) the cooler beams 20₁, 20₂, 20₃, 20₄. To cool the respective adjacent cells 80ᵢⱼ, the cooler beams 20₁, 20₂, 20₃, 20₄ themselves are cooled. According to embodiments of the present disclosure, the cooler beams 20₁, 20₂, 20₃, 20₄ have a main channel. For example, a main channel may be integrated into each of the cooler beams 20₁, 20₂, 20₃, 20₄. In each of the cooler beams 20₁, 20₂, 20₃, 20₄, a respective main channel 30₁, 30₂, 30₃, 30₄ extends along the complete length of the cooler beam. Due to the schematic nature of FIG. 1, the main channels 30₁, 30₂, 30₃, 30₄ can be identified with the cooler beams 20₁, 20₂, 20₃, 20₄ in this drawing. A detailed explanation as to the integration of the main channels 30₁, 30₂, 30₃, 30₄ into the cooler beams 20₁, 20₂, 20₃, 20₄ is provided below with reference to FIGS. 5A and 5B.

Each of the main channels includes a respective inlet I₁, I₂, I₃, I₄ and a respective outlet O₁, O₂, O₃, O₄. The inlets I₁, I₂, I₃, I₄ of the main channels 30₁, 30₂, 30₃, 30₄ are each configured to be connected with a suitable coolant supply (see below). Correspondingly, the outlets O₁, O₂, O₃, O₄ of the main channels 30₁, 30₂, 30₃, 30₄ are each configured to be connected with the suitable discharge (see below), which receives the coolant discharged by (or from) the outlets O₁, O₂, O₃, O₄ of the main channels 30₁, 30₂, 30₃, 30₄. Accordingly, when being supplied with a coolant through the respective inlets I₁, I₂, I₃, I₄, a respective flow of coolant F₁, F₂, F₃, F₄ is guided through each of the main channels 30₁, 30₂, 30₃, 30₄, as schematically indicated in FIG. 1. The coolant, when supplied to the main channels 30₁, 30₂, 30₃, 30₄ via the respective inlets I₁, I₂, I₃, I₄, is a fluid having a relatively low temperature (e.g., a temperature in a range of about 20° C. to about 55° C.) in comparison to that of the cells 80ᵢⱼ. Depending on the construction of the cooler beams 20₁, 20₂, 20₃, 20₄ and integration of the main channels into the cooler beam, the cooler beams 20₁, 20₂, 20₃, 20₄ are either identical with the main channels 30₁, 30₂, 30₃, 30₄ (e.g., the cooler beams are or entirely form the main channels) or include one or more pipes that are mechanically connected with respective interior sides of the cooler beams 20₁, 20₂, 20₃, 20₄ (see the detailed description as to FIGS. 5A and 5B, below). Accordingly, when a coolant is guided through a main channel 30₁, 30₂, 30₃, 30₄, a heat exchange occurs between the coolant and the material of the cooler beams 20₁, 20₂, 20₃, 20₄. Further, the cooler beams 20₁, 20₂, 20₃, 20₄ are each mechanically connected (directly or indirectly) by their respective first and/or second sides with the front and/or rear faces of battery cells arranged adjacent (with regard to the x-direction) to the cooler beams 20₁, 20₂, 20₃, 20₄.

Accordingly, heat exchange occurs between the coolant flowing through a main channel and the battery cells mechanically connected to the cooler beam, into which the main channel is integrated when the temperature of these cells exceeds the temperature of the coolant. For example, heat energy is transferred from the cells to the coolant through the material of the respective main channel to cool the cells. The heat exchange between a cell that is mechanically connected to the cooler beam and the coolant guided through the cooler beam by the integrated main channel depends on the area of the mechanical connection between the cell and the cooler beam. More specifically: the larger the area of the mechanical connection between the cell and the cooler beam, the larger the flow of heat energy (heat transfer) from the cell to the cooler beam and further to the coolant. As described above, each of the cells in the battery system 110 as depicted in FIG. 1 abuts with one of its largest side faces (e.g., either with its respective front face 88 or its respective rear face) against one of the cooler beams 20₁, 20₂, 20₃, 20₄. Thus, the battery system 110 provides for excellent cooling of each of the cells 80ᵢⱼ in the battery system 110.

The battery system 110 not only provides for excellent cooling of each of the individuals cells but also prevents the propagation of a thermal event (e.g., a thermal run-away) within the plurality of cells or at least considerably slows (or retards) such a propagation. This applies to the propagation of a thermal event across different groups of battery cells (see above as to the definition of a group in this context). For example, if the cell 80₁₁ depicted in the bottom left corner with regard to the top-view of FIG. 1 (e.g., the first cell of the first cell row 810) is affected by a thermal run-away, indicated in FIG. 1 as the gray-scaled cell 80₁₁, propagation of the thermal event to the cell 80₂₁ arranged next to the affected cell 80₁₁ in the x-direction (e.g., to the second cell of the first cell row 810) is avoided or at least slowed in several ways. First, the afore-mentioned first cell 80₁₁ and second cell 80₂₁ of the first cell row 810 belong to different blocks of the first cell row 810 and, thus, are spatially separated from each other. Second, the first cell 80₁₁ and the second cell 80₂₁ are mechanically shielded from each other by the first cooler beam 20₁. Third, the first cell 80₁₁ and the second cell 80₂₁ are also thermally shielded from each other in that heat propagating from the first cell 80₁₁ of the first cell row 810 is transferred into the flow of coolant F₁ flowing through the first main channel 30₁ integrated into the first cooler beam 20₁ and, thus, is immediately removed from the area between first cell 80₁₁ and second cell 80₂₁ of the first cell row 810 by the motion of the flow of coolant F₁ into the y-direction when the first main channel 30₁ is supplied with coolant via its inlet I₁. Accordingly, further propagation of the heat generated in the cell 80₁₁ affected by the thermal run-away through the second side of the first cooler beam 20₁ into the second cell 80₂₁ of first cell row 810 is mitigated or prevented. After having passed the outlet O₁ of the first main channel 30₁, the heat generated in the cell 80₁₁ and received by the flow of coolant F₁ flowing through the first main channel 30₁ is then discharged from the battery system 110, such as by the coolant discharge channel 34, which will be described below.

As described above, a coolant supply and a coolant discharge is provided for each of the main channels 30₁, 30₂, 30₃, 30₄. For each of the main channels 30₁, 30₂, 30₃, 30₄, the respective coolant supply is configured to be connected with the inlet of the main channel such that coolant provided by the coolant supply flows via the inlet into the main channel. Correspondingly, for each of the main channels 30₁, 30₂, 30₃, 30₄, the respective coolant discharge is configured to be connected with the outlet of the main channel such that coolant flowing out of the main channel via the outlet is received by the coolant discharge.

In various embodiments, each of the main channels may be connected, with their respective inlets, to the same coolant supply. In some embodiments, a single coolant supply is used to supply each of the main channels with coolant. Also, in some embodiments, each of the main channels may be connected, with their respective outlets, to the same coolant discharge. For example, a single coolant discharge is used to receive the coolant discharge from each of the main channels. For example, in the battery system 110 illustrated in FIG. 1, the coolant supply is provided by a coolant supply channel 32 and, correspondingly, the coolant discharge is provided by a coolant discharge channel 34. The coolant supply channel 32 is connected to of the inlets I₁, I₂, I₃, I₄ of any one of the main channels 30₁, 30₂, 30₃, 30₄. Similarly, the coolant discharge channel 34 is connected with the outlets O₁, O₂, O₃, O₄ of any one of the main channels 30₁, 30₂, 30₃, 30₄. The coolant supply channel 32 includes a main inlet I configured to be connected with an external cooling system configured to supply the coolant supply channel 32 with the coolant F via the main inlet I. In the battery system 110 shown in FIG. 1, the coolant supply channel 32 is part of the battery system 110. In other embodiments, the coolant supply channel 32 may be part of an external cooling system. Also, the coolant discharge channel 34 includes a main outlet O configured to be connected with an external cooling system configured for receiving the coolant F discharged from the coolant discharge channel 34 via the main outlet O. In the battery system 110 shown in FIG. 1, the coolant discharge channel 34 is part of the battery system 110. In other embodiments, the coolant discharge channel 34 may be part of an external cooling system.

As the coolant supply channel 32 supplies any one of the main channels 30₁, 30₂, 30₃, 30₄ with the coolant F, and the coolant discharge channel 34 receives the coolant discharged from each of the main channels 30₁, 30₂, 30₃, 30₄, the main channels 30₁, 30₂, 30₃, 30₄ may be considered as being connected in parallel within the channel system formed by the main channels 30₁, 30₂, 30₃, 30₄ together with the coolant supply channel 32 and the coolant discharge channel 34. Accordingly, the coolant F provided by the coolant supply channel 32 is divided into several flows of coolant F₁, F₂, F₃, F₄ such that one of these flows of coolant F₁, F₂, F₃, F₄ is guided through the corresponding one of the main channels 30₁, 30₂, 30₃, 30₄ (and thus, through the corresponding one of the cooler beams 20₁, 20₂, 20₃, 20₄) when the cooling system is operating and supplies coolant to the coolant supply channel 32. For each of the main channels 30₁, 30₂, 30₃, 30₄, the amount of coolant flowing through the channel and the velocity, with which the coolant flows through the channel, can be controlled, for example, by the pressure under which the coolant is provided by the coolant supply channel 32 and/or by the cross-sectional flowing area(s) provided by the respective main channel.

To improve or ensure the thermal isolation effect of the cooler beams, the majority of the electrical connections from among the cells (e.g., the busbars) do not connect cells along the cell row (e.g., over or through the cooler beam). Instead, the majority of electrical connectors interconnect the cells of different cell rows. For example, with reference to FIG. 1, the busbar E₁₁₁₂ from the hot cell 80₁₁ (depicted in the left bottom corner of the cell matrix) of the first cell row 810 is connected to the next cell 80₁₂ in the y-direction, which belongs to the second cell row 820. Thus, the cell 80₁₂ is only connected to the hot cell 80₁₁ by the busbar E₁₁₁₂ but is still cooled at its rear side abutting against the first cooler beam 20₁. However, one busbar E₁₃₂₃ electrically connects along the cell row direction (x-direction). This busbar from one cell block to the next (in the x-direction) is designed (or configured) to reduce or minimize heat transfer. For example, the busbar E₁₃₂₃ may be thermally connected to the cooler beams (correspondingly for the busbars E₂₁₃₁, E₃₃₄₃, E₄₁₅₁, E₅₃₆₃, E₆₁₇₁ connecting any two neighboring of the following groups of cells, respectively). According to the busbar arrangement, the required number of electrical connectors across (or through) cooler beams can be reduced.

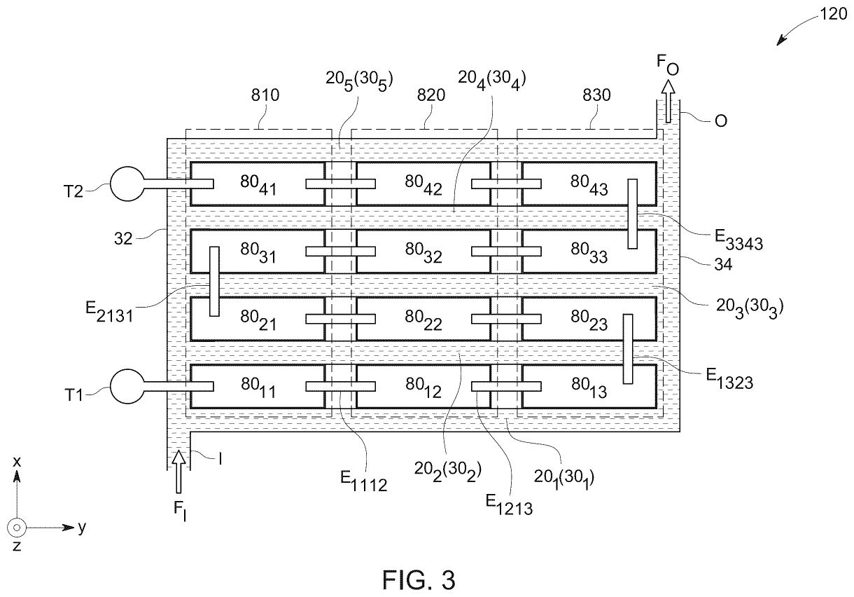

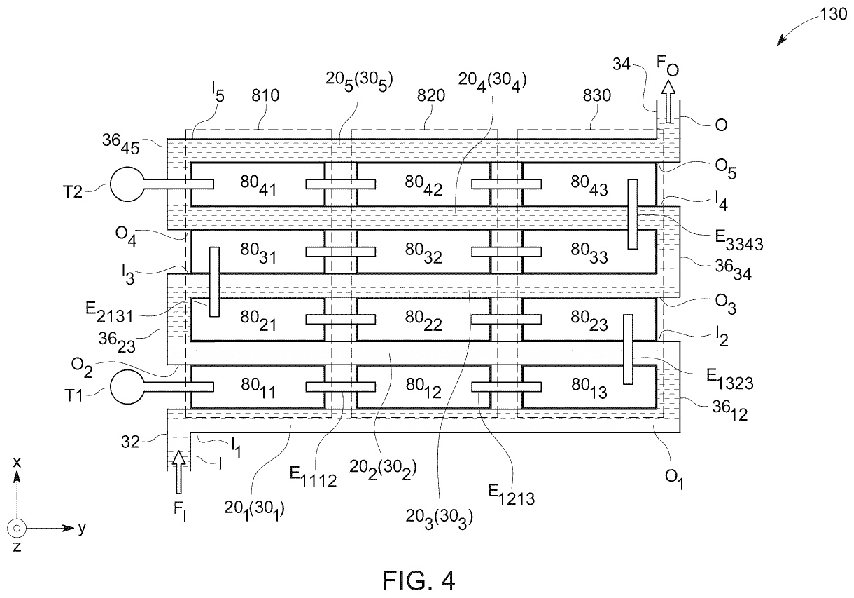

Two other embodiments of a battery system according to the present disclosure are schematically illustrated in FIGS. 3 and 4. FIG. 3 is a top view of a second embodiment of a battery system 120, and FIG. 4 is a top view of a third embodiment of a battery system 130. Again, a Cartesian coordinate system with the x, y, and z axes is included the figures to facilitate the description by referring to directions parallel to the axis. Similar to the battery system 110 shown in FIG. 1, the battery system 120 shown in FIG. 3 as well as the battery system 130 shown in FIG. 4 includes a first cell row 810, a second cell row 820, and a third cell row 830, as indicated by virtual rectangles marked by dashed lines. In each of these cell rows 810, 820, 830, the respective cells 80ᵢ₁, 80ᵢ₂, 80ᵢ₃ (with the first index i∈{1, 2, 3, 4} denoting the position of the cell with respect to the x-direction, and the second index referring to the respective cell row) are lined up along (e.g., arranged along) the x-direction. Further, the cell rows 810, 820, 830 are arranged in parallel to each other and lined up along the y-direction. For the sake of simplicity of the schematic illustrations, each of the cell rows 810, 820, 830 of the illustrated embodiments includes only four battery cells. However, other embodiments of the battery system 120 or 130 may include additional cells arranged in x-direction using the same arrangement pattern for the cells. Also, in other embodiments, additional cell rows may be added along the y-direction in the same manner as shown for the depicted cell rows 810, 820, 830.

All cells 80ᵢⱼ(i∈{1, 2, 3, 4}, j∈{1, 2, 3}) in the battery system 120 or 130 have an identical prismatic (cuboid) shape and are orientated such that their respective front faces face against the x-direction and their respective rear faces face into the x-direction (see, e.g., FIG. 2 and the respective description as to FIG. 1, where the cells are orientated in a similar manner). In each of the cell rows 810, 820, 830, the individual cells 80ᵢⱼ are spaced apart from each other with regard to the x-direction. A plurality of cooler beams 20₁, 20₂, 20₃, 20₄, 20₅ (in the following, the respective reference signs are simply referred to as 20ₖ with k∈{1, 2, 3, 4, 5}) is arranged in the battery system 120 or 130, and each of the cooler beams 20ₖ extends parallel to the y-direction. A first cooler beam 20₁ is arranged in front of the first cells 80ᵢⱼ (j∈{1, 2, 3}) of each of the cell rows 810, 820, 830, when viewed into the x-direction. Further, a second cooler beam 20₂ extends through each of the spaces, which are formed between the first cells 80ᵢⱼ (j∈{1, 2, 3}) and the second cells 80₂ⱼ (j∈{1, 2, 3}) of each of the cell rows 810, 820, 830, and the cells in each cell row are counted with respect to the x-direction. Similarly, a third cooler beam 20₃ runs through each of the spaces, which are formed between the second cells 80₂ⱼ and the third cells 80₃ⱼ of each of the cell rows 810, 820, 830, and a fourth cooler beam 20₄ runs through each of the spaces, which are formed between the third cells 80₃ⱼ and the fourth cells 80₄ⱼ of each of the cell rows 810, 820, 830. Finally, a fifth cooler beam 20₅ is arranged behind the last (e.g., the respective fourth) cells 80₄ⱼ (j∈{1, 2, 3}) of each of the cell rows 810, 820, 830, when viewed into the x-direction.

Similar to the embodiment described above with respect to FIG. 1, each of the cooler beams 20ₖ (k∈{1, 2, 3, 4, 5}) has a planar first side perpendicular to the drawing plane (e.g., parallel to the y-z-plane of the coordinate system) and facing against the x-direction as well as a planar second side being perpendicular to the drawing plane but facing into the x-direction. Accordingly, each of the first and second side of each of the cooler beams 20ₖ is arranged parallel to each of the front and rear face of each of the cells 80ᵢⱼ in the battery system 120 or 130.

Due to this arrangement of cells 80ᵢⱼ and cooler beams 20ₖ, the cell rows 810, 820, 830 are each divided into a plurality of blocks in a similar way as described above with respect to FIG. 1. Different from the embodiment shown in FIG. 1, however, in the second embodiment (FIG. 3) and the third embodiment (FIG. 4) the cell rows 810, 820, 830 are divided into cell blocks such that each of the blocks only includes a single battery cell. Furthermore, each of the front face and the rear face of the cells positively abuts against the respective second side or first side of the adjacent cooler beams 20ₖ. For example, in the second embodiment shown in FIG. 3 and the third embodiment shown in FIG. 4, each of the cells is arranged between two cooler beams and positively abuts with two of its faces against the cooler beams. Because the front and rear faces of the cells are the cell's largest faces (see, e.g., FIG. 2), excellent heat exchange between the cooler beams 20ₖ and the cells 80ᵢⱼ is ensured. Because both large faces of each of the cells are in thermal contact with the cooler beam, the cooling effect provided to the cells 80ᵢⱼ by the cooler beams 20ₖ of the embodiments shown in FIGS. 3 and 4 (when the cooling system operated) is more efficient in comparison to the cooling effect provided by the first embodiment shown in FIG. 1 in which only one of the front and rear faces of each of the cells is involved in heat exchange with the cooler beams. In fact, the area used for the heat exchange in the embodiments shown in FIGS. 3 and 4 is twice as large as in the first embodiment shown in FIG. 1. Thus, the second embodiment shown in FIG. 3 and the third embodiment shown in FIG. 4 provide maximum heat exchange with the cooler beams and, thus, allow for maximally efficient cooling effect.

Similar to the embodiment described above with respect to FIG. 1, the cells 801 of the battery system 120 or 130 are grouped into several groups due to the intersection of the cell rows 810, 820, 830 by the plurality of cooler beams 20ₖ. Each group includes any one of the cells positioned between one pair of neighboring cooler beams. For example, in the second embodiment shown in FIG. 3 and the third embodiment shown in FIG. 4, the k-th group of cells is provided by the set of cells {80ᵢ₁, 80ᵢ₂, 80ᵢ₃} positioned between the k-th cooler beam 20ₖ and the (k+1)-th cooler beam 20ₖ₊₁ (k∈{1, 2, 3, 4}), when viewed into the x-direction.

The cells of each group are electrically connected to each other in series. The electrical connections may be established by wires or busbars. For example, with regard to the first group, one of the terminals of the cell 80₁₁ depicted in the left bottom corner of the matrix of cells shown in FIGS. 3 and 4 is connected via a busbar E₁₁₁₂ to a terminal of the cell 80₁₂ arranged next to it (with respect to the y-direction) in the first group, and the other terminal of the latter cell 80₁₂ is connected by another busbar E₁₂₁₃ to a terminal of the third cell 80₁₃ in the first group. To establish a serial connection, the connections are arranged such that negative terminals are connected only with positive terminals. The same connection scheme is applied in a corresponding manner to each of the other groups of cells in the battery systems 120 and 130. Further, the groups of cells themselves are electrically connected to each other in series. For example, with reference to FIGS. 3 and 4, the first group is connected to the second group by a busbar E₁₃₂₃ that electrically connects a terminal of the rightmost cell 80₁₃ of the first group with a terminal of the rightmost cell 80₂₃ of the second group. Also, the second group is connected to the third group by another busbar E₂₁₃₁ that electrically connects a terminal of the left cell 80₂₁ of the second group with a terminal of the left cell 80₃₁ of the third group. The third group is then connected in a similar manner to the fourth group by another busbar E₃₃₄₃. Again, negative terminals are connected only with positive terminals to establish a serial connection. Thus, each of the groups are connected in series, and within each of the groups, the cells are connected in series. Thus, the complete set of cells in the battery system 120 or 130 is connected in series. Then, the free terminal of cell 80ᵢⱼ depicted in the left bottom corner and the free terminal of the cell 80₄₁ depicted in the left upper corner in the matrix of cells as shown in FIGS. 3 and 4 act as the first terminal T1 and the second terminal T2 of the complete battery system 120, 130. In the arrangements of the second embodiment shown in FIG. 3 and the third embodiment shown in FIG. 4, each of the cooler beams 20ₖ is bridged or crossed by only one busbar, similar to the configuration of the first embodiment shown in FIG. 1. Thus, in each of the described embodiments, unwanted heat transfer between neighboring groups of cells via the electrical connectors between these groups is reduced.

Further, a main channel is integrated in each of the cooler beams 20₁, 20₂, 20₃, 20₄, 20₅. For example, a first main channel 30₁ is integrated into the first cooler beam 20₁, and a second main channel 30₂ is integrated into the second cooler beam 20₂. Generally, a k-th main channel 30ₖ is integrated into the respective k-th cooler beam 20ₖ (k∈{1, 2, 3, 4, 5}) according to the embodiments shown in FIGS. 3 and 4. In FIGS. 3 and 4, the main channels 30ₖ are depicted—for the sake of simplicity—as being identical with the respective cooler beams 20ₖ. This may correspond to the embodiment of the main channels explained below with reference to FIG. 5A.

However, another embodiment of the main channels as illustrated in FIG. 5B may also be used in the second and/or third embodiment of the battery system 120 or 130. Each of the main channels 30ₖ is configured to guide a coolant along the complete length of the cooler beam 20ₖ, into which the main channel is integrated. Thus, when coolant is flowing through a main channel, heat exchange occurs between each of the battery cells positively abutting against the respective cooler beam and the coolant through the cooler beam. Hence, provided that the temperature of the coolant is lower than the temperature of the battery cells abutting against the respective cooler beam, these cells are cooled in the arrangement provided by the battery system 120 or 130. Also, a propagation of a thermal event (e.g., a thermal run-away) occurring in one of the groups to the other groups of the battery system 120, 130 is avoided or at least considerably slowed (or retarded) due to the mechanical separation provided by the cooler beams as well as by the movement of flowing coolant within the cooler beams, which conveys the heat received by the coolant away from the area where the heat is generated (e.g., the area of a battery cell affected by a thermal event). This has already been explained above in more detail in the context of FIG. 1.

The second embodiment illustrated in FIG. 3 and the third embodiment illustrated in FIG. 4 differ from each other in the way fresh coolant (i.e., coolant not having received heat from the battery cells 801) is supplied to each of the main channels 30ₖ, and how the coolant having passed through the main channels 30ₖ (used coolant) is discharged from the main channels 30ₖ. In the second embodiment as illustrated in FIG. 3, the coolant supply and the discharging of coolant is provided in a similar manner as described above in the context of the first embodiment with reference to FIG. 1. For example, each of the main channels 30ₖ includes an inlet (left end of the respective main channel in FIG. 3) and an outlet (right end of the respective main channel in FIG. 3). A coolant supply channel 32 is connected to the inlets of each of the main channels 30ₖ. Also, a coolant discharge channel 34 is connected to the outlets of each of the main channels 30ₖ. In other words, the coolant supply channel 32 is in fluid connection to each of the main channels 30ₖ, and the coolant discharge channel 34 is also in fluid connection with each of the main channels 30ₖ. Then, fresh coolant can be supplied, by the coolant supply channel 32, to each of the main channels 30ₖ, and, correspondingly, used coolant discharged from the main channels 30ₖ is received by coolant discharge channel 34. Hence, in the battery system 120 shown in FIG. 3, the main channels 30₁, 30₂, 30₃, 30₄, 30₅ can be considered as being connected in parallel within the channel system formed by the main channels 30₁, 30₂, 30₃, 30₄, 30₅ together with the coolant supply channel 32 and the coolant discharge channel 34.

The third embodiment of the battery system 130 as illustrated in FIG. 4 provides an alternative way of connecting the main channels 30₁, 30₂, 30₃, 30₄, 30₅. Again, each of the main channels 30ₖ (k∈{1, 2, 3, 4, 5}) includes an inlet Iₖ (one end of the respective main channel in FIG. 4) and an outlet Oₖ (the other end of the respective main channel in FIG. 4). Here, however, for each of the main channels 30ₖ (except for the fifth main channel 30₅, i. e., k∈{1, 2, 3, 4}), the respective outlet Oₖ is connected with the inlet Iₖ₊₁ of the respective next main channel 30ₖ₊₁, when viewed into the x-direction. The connections are realized by a plurality of respective connection channels 36₁₂, 36₂₃, 36₃₄, 36₄₅. For example, the outlet O₁ of the first main channel 30₁ is connected to the inlet I₂ of the second main channel 30₂ via a first connection channel 36₁₂. Similarly, the outlet O₂ of the second main channel 30₂ is connected to the inlet I₃ of the third main channel 30₃ via a second connection channel 36₂₃. Then, the outlet O₃ of the third main channel 30₃ is connected to the inlet I₄ of the fourth main channel 30₄ via a third connection channel 36₃₄, and finally, the outlet O₄ of the fourth main channel 30₄ is connected to the inlet I₅ of the fifth main channel 30₅ via a fourth connection channel 36₄₅.

Furthermore, the inlet I₁ of the first main channel 30₁ is connected to a coolant supply channel 32, and outlet O₅ of the fifth (last) main channel 30₅ is connected to a coolant discharge channel 34. Hence, in the battery system 130 as illustrated by FIG. 4, the main channels 30₁, 30₂, 30₃, 30₄, 30₅ can be considered as being connected in series within the channel system formed by the main channels 30₁, 30₂, 30₃, 30₄, 30₄, 30₅ together with the connection channels 36₁₂, 36₂₃, 36₃₄, 36₄₅ and the coolant supply channel 32 as well as the coolant discharge channel 34.

In each of the second embodiment of the battery system 120 (FIG. 3) and third embodiment of the battery system 130 (FIG. 4), the coolant supply channel 32 includes a main inlet I configured to be connected with an external cooling system configured to supply the coolant supply channel 32 with fresh coolant F₁ via the main inlet I. In the second and third embodiments of the battery system 12 and 130, the coolant supply channel 32 is part of the battery system 120, 130. In other embodiments, the coolant supply channel 32 may be part of an external cooling system. Also, the coolant discharge channel 34 includes a main outlet O configured to be connected with an external cooling system configured to receive used coolant F_{O} discharged from the coolant discharge channel 34 via the main outlet O. In the second and third embodiments of the battery system 120 and 130, the coolant discharge channel 34 is part of the battery system 120, 130. In other embodiments, the coolant discharge channel 34 may be part of the external cooling system.

In each of the embodiments described above with reference to FIGS. 1, 3, and 4, the flow direction of the coolant and any point within the channel system can be reversed by using the main inlet I of the channel system as an outlet and using the main outlet O of channel system as an inlet. The cooling effect of the channel system on the battery system 110, 120, or 130 is not affected or substantially affected by such a reversed operation.

FIGS. 5A and 5B each show, in a schematical manner, a cross-sectional view through two embodiments of a cooler beam 20 that can be used in the battery system according to embodiments the present disclosure. The cooler beam 20 is arranged adjacent to and between two battery cells 80_{i,j} and 80_{i+1,j}. Accordingly, the cooler beam 20 may be any one of the first, second, third, fourth cooler beam 20₁, 20₂, 20₃, 20₄ in the first embodiment shown in FIG. 1 or any one of the second, third, fourth cooler beam 20₂, 20₃, 20₄ in the second or third embodiment shown in FIGS. 3 and 4. Further, the battery cells 80_{i,j} and 80_{i+1,j} belong to same cell row (the j-th cell row) in a battery system according to the present disclosure. For example, the cell 80_{i,j} depicted on the right side in FIGS. 5A and 5B (in the following shortly referred to as “right cell”) may correspond to the third cell 80₃₂ of the second cell row of one of the first, second, or third embodiment described in the foregoing, and the cell 80_{i+1,j} depicted on the left side in FIGS. 5A and 5B (in the following shortly referred to as “left cell”) may correspond to the fourth cell 80₄₂ of the second cell row of the respective embodiment (then, to obtain this example, one may set i=3 and j=2). Then, the Cartesian coordinate system, which is also included in FIGS. 5A and 5B is consistent with the coordinate systems of the foregoing FIGS. 1 to 4.

In the embodiment shown in FIG. 5A, the cross-sectional profile of the cooler beam 20 has a rectangular shape. The cooler beam 20 has a first wall 20a abutting against the rear face 89_{i,j} of the right cell 80_{i,j} and a second wall 20b abutting against the front face 88_{i+1,j} of the left cell 80_{i+1,j}. To establish a mechanical fixation between the cooler beam 20 and the cells 80_{i,j}, 80_{i+1,j}, the latter may be adhered to the cooler beam by, for example, adhesives. For example, a first adhesive layer 26a may be arranged between the rear face 89_{i,j} of the right cell 80_{i,j} and the outer face of the first wall 20a, and, correspondingly, a second adhesive layer 26b may be arranged between the front face 88_{i+1,j} of the left cell 80_{i+1,j} and the outer face of second wall 20b. Then, the outer face of the first wall 20a forms the first side 22a of the cooler beam 20, and the outer face of the second wall 20b forms the second side 22b of the cooler beam 20. Further, the cooler beam 20 has a bottom wall 20c and a top wall 20d. The bottom wall 20c connects (e.g., extends between) the bottom edges (with respect to FIG. 1) of the first and second walls 20a, 20b to each other, and the top wall 20d connects (e.g., extends between) the top edges (with respect to FIG. 1) of the first and second walls 20a, 20b to each other. Accordingly, the cross-sectional profile of the cooler beam 20 encloses a channel (or space) 30 for guiding a fluid, such as a coolant. In other words, the cooler beam 20 is itself configured to act as a channel 30 in that a pipe is formed by the entirety of first and second wall 20a, 20b as well as the bottom wall 20c and the top wall 20d of the cooler beam 20. Thus, the main channel is integrated in the cooler beam 20 and is formed by the channel 30.

The cooler beam 20 according to the embodiment shown in FIG. 5A must be designed to have a sufficient mechanical stability to overcome (or resist) the cell swelling forces along the cell stack (e.g., along the x-direction). However, at the same time, the thermal conductivity along the cell stack should be minimized. To protect the cooler beam 20 against the high temperatures of the cell in case of a thermal run-away (e.g., about 700° C.), the cooler beam 20 may be made of steel.

As indicated by the flame symbols R depicted within the left cell 80_{i+1,j}, one of the cells adjacent to the cooler beam 20 may be affected by a thermal event (e.g., the occurrence or generation of an abnormally high temperature within the battery cell) such as a thermal run-away (in the latter case, temperatures of about 700 C may be generated). In FIG. 5A, the temperature is schematically indicated (on a relative scale without reference values) by shading of areas within a cell according to the scale, with the light gray denoting a relatively low temperature or the normal operation temperature of the cell, a medium gray denoting a medium temperature, and a dark gray denoting a high temperature generated by the thermal event. The thermal event R may be detected by a suitable detection system connected with an evaluation unit, which may be integrated in, for example, the battery management unit (BMU) of the battery system according to embodiments of the present disclosure (see above). Upon detection of the thermal event, the BMU may start a cooling system connected with the channel system of the battery system. For example, with reference to the embodiments shown in FIGS. 1, 3, and 4, the cooling system may be connected to the main inlet I of the coolant supply channel 32 of the battery system 110, 120, or 130 and may be further configured to supply the coolant supply channel 32 with fresh coolant. Correspondingly, the cooling system may be connected to the main outlet O of the coolant discharge channel 34 and may be configured to receive used coolant discharged from the main channels of the battery system. Thus, after being started, coolant having a considerably lower temperature (e.g., about 35° C.) than the cells—and in particular lower than the temperature of the cell affected by the thermal event R—is guided through each of the main channels. Then, in this situation, a temperature gradient arises in the area between the left cell 80_{i+1,j} affected by the thermal event R and the coolant flowing within the channel 30. Because the second wall 20b is located, in the illustrated example, in this area, heat transfer is generated through the material of the second wall 20b. For example, heat propagates from the hot area within the left cell through the second wall 20b into the coolant within the main channel 30. Thereby, thermal energy is released from the left cell 80_{i+1,j}, and the temperature of the left cell 80_{i+1,j} is thereby reduced. As can be seen from FIG. 5A, most of the interior side 23b of the second wall 20b is thermally connected to the coolant. Thus, most of the thermal energy propagating through the second wall 20b is received by the coolant and, thus, guided away from the area of the thermal event R and then discharged out of the battery system. Only a rather small amount of heat energy may propagate, via the bottom wall 20c and the top wall 20d, to the opposite first wall 20a, thereby on slightly increasing the temperature of the opposite first wall 20a. This effect is further muted because the bottom wall 20c and the top wall 20d each contact the coolant and are, thus, cooled. Accordingly, the heat transfer from the left cell 80_{i+1,j} to the right cell 80_{i,j} is largely prevented. Thus, the temperature of the right cell 80_{i,j} is kept below about 150° C. even when a thermal event occurs in the left cell 80_{i+1,j}.

As already indicated above, the cooler beam 20 shown in FIG. 5A may be made of steel. The lower thermal conductivity of steel compared to aluminum can be compensated for by the increased cooling surface (e.g., the areas of the front face 88_{i+1,j} and the second side 22b of the cooler beam 20). Steel also helps to provide sufficient stability of the cooler beam 20 against cell swelling forces arising from the cells when being operated or in case of thermal events. Further, due to the steel material, the required cross-section of material present between the left cell 80_{i+1,j} and the right cell 80_{i,j} may be reduced, which leads to a lower thermal conductivity between the left cell 80_{i+1,j} and the right cell 80_{i,j}.

Another embodiment of the cooler beam 20 is shown in FIG. 5B, which may be made of aluminum. The cooler beam 20 shown in FIG. 5B is manufactured as an aluminum extrusion profile. Similar to the cooler beam shown in FIG. 5A, the cooler beam 20 shown in FIG. 5B has a first wall 20a abutting against the rear face 89_{i,j} of the right cell 80_{i,j} and a second wall 20b abutting against the front face 88_{i+1,j} of the left cell 80_{i+1,j}. However, different from the cooler beam shown in FIG. 5A, the cooler beam 20 shown in FIG. 5B does not have a bottom wall or a top wall. Instead, a plurality of pipes is arranged on each of the interior sides (e.g., the side 23a of first wall 20a facing the second wall 20b and the interior side 23b of the second wall 20b facing the first wall 20a). In the illustrated embodiment, three first pipes 41a, 41b, 41c are arranged on the interior side 23a of the first wall 20a, and three second pipes 42a, 42b, 42c are arranged on the interior side 23b of the second wall 20b. Each of the pipes 41a, 41b, 41c, 42a, 42b, 42c may extend across the complete length of the cooler beam 20 along the y-direction (i.e., perpendicular to the drawing plane). Each of the pipes has a cavity C configured to guide a coolant. The pipes are positioned pairwise such that for every pair, the pipes are arranged opposite to each other on the opposite interior sides 23a, 23b of the walls 20a, 20b. For example, one pair may be located near the top edges of the walls 20a, 20b (the terms “top,” “bottom,” “upper,” and the like used with reference to FIG. 5B in the present context). This pair includes a first top pipe 41a arranged on the interior side 23a of the first wall 20a and a second top pipe 41b arranged on the interior side 23b of the second wall 20b, and the second top pipe 42a may be positioned opposite to the first top pipe 41a with respect to the x-direction. To provide mechanical stability to the cooler beam 20, the first top pipe 41a and the second top pipe 42a are mechanically connected to each other by an upper rod or rib 44a. The rod or rib 44a is connected to the first top pipe 41a on an area of the first top pipe 41a, which faces the second wall 20b. Correspondingly, the rod or rib 44a is connected to the second top pipe 42a on an area of the second top pipe 42a that faces the first wall 20a. Thus, the upper rod or rib 44a is not in direct mechanical contact to any one of the first and second wall 20a, 20b. Hence, the upper rod or rib 44a is also not in direct thermal contact to any one of the first and second wall 20a, 20b. Furthermore, when coolant flows through the first and second top pipes 41a, 42a, the first and second top pipes 41a, 42a are cooled such that the areas on these pipes facing away from the respective interior sides 23a, 23b of the walls 20a, 20b, on which the pipes are arranged, will have a lower temperature than the respective interior sides 23a, 23b. Due to these effects, the active cooling by the coolant and the avoidance of direct mechanical contact to the interior sides 23a, 23b, thermal heat exchange between the first wall 20a and the second wall 20b of cooler beam 20 is reduced or minimized. A further pair of pipes 41c, 42c arranged opposite to the outer on the interior sides 23a, 23b of the walls 20a, 20b is arranged, in a corresponding manner with regard to the assembly along the x-direction, at the bottom edges of the walls 20a, 20b, and still a further pair of pipes 41b, 42b is arranged, in a similar manner as described before, in the centered areas (with regard to the z-direction) of the interior sides 23a, 23b of the walls 20a, 20b.

The cooler beam 20 shown in FIG. 5B provides sufficient mechanical stability to overcome the cell swelling forces along the cell stack (e.g., along the x-direction) and, at the same time, reduces or minimizes the thermal conductivity along the cell stack. As already indicated above, the cooler beam 20 may be an aluminum extrusion profile. To protect the aluminum against the very high temperatures of the cells (during normal operation mode, and in particular, during a thermal event), additional mica sheets 24a, 24b or similar material may be used between the cells and the cooler beam 20. This material slows down thermal transfer from the cells to the cooler beam and will allow the cooler beam 20 to stay at lower temperatures. The aluminum extrusion profile is designed such that on each side the coolant (e.g., cooling water) flows throw a plurality of pipes 41a, 41b, 41c, 42a, 42b, 42c. To reduce or minimize the thermal connection across the cooler beam 20, only small rods or ribs 44a, 44b, 44c connect the left and the right half of the cooling pipes 41a, 41b, 41c, 42a, 42b, 42c. In addition, these connections are based on the cooling pipes 41a, 41b, 41c, 42a, 42b, 42c rather than on the walls 20a, 20b.

When a thermal event, such as a thermal run-away, occurs, which is indicated again by the flame symbols R depicted in the left cell 80_{i+1,j} (see the above remarks as to FIG. 5A), thermal propagation to the right cell 80_{i,j} is largely prevented by the construction of the cooler beam 20 shown in FIG. 5B, due to several effects. First, the left cell 80_{i+1,j} as well as the right cell 80_{i,j} are cooled by heat exchange with the coolant. Second, the mechanical contact between the first wall 20a and the second wall 20b by solid members of the cooler beam 20 (such as the rods or ribs 44a, 44b, 44c) is minimized. Third, the rods or ribs 44a, 44b, 44c themselves are cooled by the coolant and are, additionally, arranged on “cooled areas” of the pipes 41a, 41b, 41c, 42a, 42b, 42c as explained above.

In certain application, another embodiment of a cooler beam may be sufficient that is similar to the cooler beam 20 shown in FIG. 5B except for the arrangement of the pipes, with the pipes being arranged only on one of the interior sides 23a, 23b of the cooler beam 20. This may be most applicable in the battery systems shown in FIGS. 3 and 4 for cooler beams designed as the first beam 20₁ or the last (fifth) beam 20₅. Because these cooler beams are arranged such in the battery system 120 or 130 that cells are arranged only adjacent to one of their first and second sides, the respective other side does not need to be cooled and, thus, some of the pipes can be omitted.

Some Reference Signs
20, 20₁, 20₂, 20₃, 20₄, 20₅, 20ₖ cooler beams
20a, 20b, 20c, 20d walls
22a first side of cooler beam
22b second side of cooler beam
23a, 23b interior sides of cooler beam
24a, 24b thermally insulating layers
26a, 26b adhesive layers
30, 30₁, 30₂, 30₃, 30₄, 30₅, 30ₖ main channels
32 coolant supply channel
34 coolant discharge channel
36₁₂, 36₂₃, 36₃₄, 36₄₅ connection channels
41a, 41b, 41c pipes
42a, 42b, 42c pipes
44a, 44b, 44c rods or ribs
80, 80_{i,j}, 80_{i+1,j} battery cells
80₁₁, 80₂₁, 80₃₁, 80₄₁, 80₅₁, 80₆₁, 80₇₁, 80₈₁ battery cells (of first cell row)
80₁₂, 80₂₂, 80₃₂, 80₄₂, 80₅₂, 80₆₂, 80₇₂, 80₈₂ battery cells (of second cell row)
80₁₃, 80₂₃, 80₃₃, 80₄₃, 80₅₃, 80₆₃, 80₇₃, 80₈₃ battery cells (of third cell row)
81, 82 terminals (of battery cell)
83 venting outlet
84 top face
86 lateral face
88, 88_{i+1,j} front face
89_{i,j} rear face
110, 120, 130 battery systems
810 first cell row
820 second cell row
830 third cell row
b₁₂ area between the first and second cell row
b₂₃ area between the second and third cell row
C cavity
E₁₁₁₂, E₁₂₁₃, E₁₃₂₃, E₂₁₃₁, E₃₃₄₃ busbars
E₄₁₅₁, E₅₃₆₃, E₆₁₇₁, E₂₁₂₂, E₂₂₂₃ busbars
E₃₁₃₂, E₃₂₃₃, busbars
F coolant
F₁, F₂, F₃, F₄ flow of coolant in main channels
F_{I} fresh coolant
F_{O} used coolant
I main inlet
I₁, I₂, I₃, I₄, I₅ inlets (of main channels)
O main outlet
O₁, O₂, O₃, O₄, O₅ outlets (of main channels)
R thermal event (e. g., thermal run-away)
T1 first terminal (of battery system)
T2 second terminal (of battery system)
x, y, z axes of a Cartesian coordinates system

What is claimed is:

1. A battery system comprising:
a plurality of cell rows, each of the cell rows comprising a plurality of cells arranged in a row extending along a first direction, each of the cells having a prismatic shape formed by a planar front face and a planar rear face, each arranged perpendicular to the first direction, a first lateral face, a second lateral face, a bottom face and a top face, and for each cell, the front face is arranged in front of the rear face when viewed in the first direction;
a plurality of cooler beams, each of the cooler beams having a planar first side and a planar second side, both of which are arranged perpendicular to the first direction, and the first side is arranged in front of the second side when viewed in the first direction; and
a channel system comprising a plurality of main channels, each of the main channels being configured to guide a coolant,
wherein each of the cell rows is sub-divided into a plurality of blocks, each of the blocks comprising at least one of the cells and having a front side and a rear side, the front side being formed by the front face of a first one of the cells of the corresponding block and the rear side being formed by the rear face of a last one of the cells of the corresponding block when viewed in the first direction,
wherein, for each of the blocks, the front side of the block positively abuts against the second side of a corresponding one of the cooler beams and/or the rear side of the block positively abuts against the first side of a corresponding other one of the cooler beams, and
wherein, for each of the cooler beams, one of the main channels is integrated in the corresponding cooler beam and is thermally connected thereto.

2. The battery system according to claim 1, further comprising a carrier framework having a base portion,
wherein each of the cells is thermally insulated from the base portion.

3. The battery system according to claim 2, wherein, for any two of the cells arranged adjacent to each other in a second direction, the lateral side of one of the cells facing a lateral side of the other one of the cells is thermally insulated from the lateral side of the other one of the cells.

4. The battery system according to claim 3, wherein a thermal insulation between each of the cells and the base portion is an air gap, at least a partial air gap, or an insulation layer, and
wherein the thermal insulation between any two of the cells arranged adjacent to each other in the second direction is an air gap, at least a partial air gap, or an insulation layer.

5. The battery system according to claim 1, wherein each of the front face and the rear face of the cells has a larger area than each of the first lateral face and the second lateral face of the cells.

6. The battery system according to claim 1, wherein each of the cooler beams positively abuts one of the front side and the rear side of at least one of the blocks of each of the cell rows.

7. The battery system according to claim 6, wherein each of the cell rows comprises a same number of the blocks,
wherein, for each of the cell rows, the rear side of a first one of the blocks positively abuts the first side of one of the cooler beams and the front side of a last one of the blocks positively abuts the second side of one of the cooler beams when viewed in the first direction, and
wherein, for each of the blocks arranged in one of the cell rows between the first one of the blocks and the last one of the blocks, when viewed in the first direction, the front side of the block positively abuts the second side of one of the cooler beams and the rear side of the block positively abuts the first side of one of the cooler beams.

8. The battery system according to claim 1, wherein each of the blocks comprises at most two of the cells.

9. The battery system according to claim 1, wherein each of the blocks comprises a single one of the cells.

10. The battery system according to claim 1, wherein each of the cooler beams comprises a pipe extending along the second direction, and
wherein the pipe has a first planar side portion forming the first planar side of the cooler beam that comprises the pipe and a second planar side portion forming the second planar side of the cooler beam that comprises the pipe.

11. The battery system according to claim 1, wherein each of the cooler beams comprises an aluminum cooler core arranged between two thermally insulating layers.

12. The battery system according to claim 11, wherein the aluminum cooler core has a first wall and a second wall,
wherein the first and second walls each extend along the second direction and are arranged opposite to each other in the first direction, and
wherein the first wall is arranged in front of the second wall when viewed in the first direction.

13. The battery system according to claim 12, wherein, for each of the cooler beams, the main channel integrated into the corresponding cooler beam comprises:
a first cooling pipe extending along the second direction and arranged on a side of the first wall facing the second wall; and
a second cooling pipe extending along the second direction and arranged on a side of the second wall facing the first wall.

14. The battery system according to claim 13, wherein the first wall and the second wall are connected to each other by rods or ribs, and
wherein each of the rods or ribs extends between one of the first cooling pipes and one of the second cooling pipes.

15. The battery system according to claim 1, further comprising:
a cooling system configured to be activated and deactivated;
a battery management unit; and
a detection system configured to detect, for at least some of the cells, whether or not a thermal event occurs in the cell and, when the thermal event is detected, to send a signal to the battery management unit,
wherein the battery management unit is configured to receive the signal from the detection system and to activate the cooling system upon receiving the signal from the detection system, and
wherein the cooling system is further configured to supply, when activated, each of the main channels with a coolant.

16. A vehicle comprising at least one of the battery systems according to claim 1.
